(19) United States
(12) Patent Application Publication
(10) Pub. No.: US 2007/0171776 A1
(43) Pub. Date: Jul. 26, 2007

(54) Objective lens driver, method of manufacturing objective lens driver, optical pickup device and optical disk apparatus

(75) Inventors: Susumu Uragami, Kumamoto (JP); Shinji Tanaka, Fukuoka (JP); Junichi Yoshimoto, Oita (JP); Shinji Shuto, Oita (JP); Hideki Toyoda, Oita (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/656,569

(22) Filed: Jan. 23, 2007

(30) Foreign Application Priority Data
Jan. 25, 2006 (JP) 2006-015916
Jun. 27, 2006 (JP) 2006-176214

(51) Int. Cl. G11B 7/00

(52) U.S. Cl. 369/44.15

(57) ABSTRACT

An objective lens driver includes: a lens holder, for holding an objective lens; a first focusing coil, for moving one end of the lens holder in the focusing direction; a second focusing coil, for moving the other end of the lens holder in the focusing direction; a tracking coil assembly, for moving the lens holder in the tracking direction; and flexible members, which includes a first flexible member pair, for feeding a current to the first focusing foil, a second flexible member pair, for feeding a current to the second focusing coil, and a third flexible member pair, for feeding a current to the tracking coil assembly, wherein the lens holder is flexibly supported at a driver main body by the flexible members, and wherein the flexible members are arranged in a plurality of columns on both ends of the lens holder.

### BACKGROUND

1. Field of the Invention

The present invention relates to an objective lens driver to preferably be mounted on an electronic apparatus, such as a personal computer, a method for manufacturing the objective lens driver, an optical pickup device and an optical disk apparatus.

2. Description of the Related Art

Optical disk apparatuses have been changed from CDs (Compact Discs) to DVDs (Digital Versatile Discs), and further, BDs (Blue-ray Discs) and HD DVDs (High Definition DVDs) have been developed. On the other hand, optical disk apparatuses have been developed by adding not only functions for simply reproducing information recorded on optical disks, but also functions for recording information on optical disks. Furthermore, optical pickup devices that are mounted on optical disk apparatuses to perform the recording and reproduction of information relative to optical disks have also been advanced, in consonance with these developments.

FIG. 15 is a diagram showing the objective lens driver of a conventional optical pickup device that can perform the recording and reproduction of a CD and a DVD. An objective lens 101 is a lens that condenses a laser beam emitted by a laser light source (not shown), so as to focus on the recording face of an optical disk (not shown). The objective lens 101 is fixed to a lens holder 102, which secures a first focusing coil 106a, a second focusing coil 106a and tracking coils 107. One end of each of six flexible members is fixed to the lens holder 102, and the other end is fixed to a fixing member 104. The six flexible members 103 are arranged at both ends of the lens holder 102, in one column in the tracking direction of a optical disk, and in three rows, in the focusing direction of the optical disk. The gap between the top and bottom flexible members 103 fixed to the lens holder 102 is about 1.32 mm, and the gap between the middle and top flexible members 103 and the gap between the middle and bottom flexible members 103 are about 0.62 mm. The fixing member 104 is fixed to yokes 105, which are then secured to the carriage (not shown) of the optical pickup device. Magnets 108 are also fixed to the yokes 105. The lens holder 102 mounting the objective lens 102 can be flexibly supported by the flexible members 103 and move in the focusing direction and in the tracking direction of the optical disk.

The tracking coils 107 are electrically connected to each other, and are connected to the end of the third flexible member pair 103 on the lens holder 102 side. The two focusing coils 106 are connected, as a first focusing coil 106a and a second focusing coil 106b, respectively to the end of the first flexible member pair 103a and the end of the second flexible member pair 103b on the lens holder 102 side. The ends of the flexible members 103 on the fixing member 104 side are connected to conductive lines (not shown) that supply a current to the focusing coils 106 and the tracking coils 107. In this manner, the six flexible members 103 serve also as conductive lines for feeding power to the first focusing coil 106a, the second focusing coil 106b and the tracking coils 107. The first focusing coil 106a, the second focusing coil 106b, the tracking coils 107 and the magnets 108 constitute a magnetic circuit, and when a current flows through the first focusing coil 106a, the second focusing coil 106b and the tracking coils 107, through the employment of electromagnetic force, the lens holder 102 mounting the objective lens 101 can be moved in the focusing direction or the tracking direction of the optical disk.

In the case of DVD recording, the inclination of the objective lens 101, especially in the tracking direction of an optical disk, greatly influences the characteristics. Therefore, the optical pickup device used for DVD recording is designed to control the inclination of the objective lens. In order to control the inclination of the objective lens 101, a current to be fed to the first focusing coil 106a and the second focusing coil 106b is independently controlled, and electromagnetic force generated by the individual coils 106 is adjusted.

According to JP-A-2003-203373, in addition to this control operation, an object lens driver is made thinner by changing a magnetic circuit.

The thickness of an optical disk apparatus has also been reduced, and accordingly, a thin type of optical pickup device for mounting on is also requested. To respond to this request, a slim objective lens driver is also required. When the thickness of the objective lens driver is reduced, the gap between the top and bottom flexible members must be further narrowed. However, it becomes difficult for the gap between the top and bottom flexible members to be narrowed further when three rows of flexible members be arranged in the direction of the thicknesses at both ends of the lens holders. That is, a problem has arisen in that the required space can not be obtained for the connection of the flexible members to the focusing coils and the tracking coils, and the connection of the flexible members to conductive lines to feed power to the focusing coils and the tracking coils. As another problem, when the flexible members, the lens holder and the fixing members are to be integrally formed in order to reduce the gap between the individual flexible members, the thickness of the spacers to be inserted into these flexible members can not be obtained.

### SUMMARY

To resolve these problems, one objective of the present invention is to provide a thin type of objective lens driver that can control the inclination of an objective lens relative to an optical disk, a method for manufacturing this objective lens driver, an optical pickup device and an optical disk apparatus.

To achieve this objective, according to this invention, an objective lens driver comprises:

a lens holder, for holding an objective lens that focuses a laser beam on an optical disk;

a first focusing coil, for moving one end of the lens holder in a focusing direction of the optical disk;

a second focusing coil, for moving the other end of the lens holder in the focusing direction of the optical disk;

a tracking coil assembly, for moving the lens holder in a tracking direction of the optical disk; and

flexible members including
a first flexible member pair, for feeding a current to the first focusing foil,
a second flexible member pair, for feeding a current to the second focusing coil, and
a third flexible member pair, for feeding a current to the tracking coil assembly,

wherein the lens holder is flexibly supported at a driver main body by the flexible members, and the flexible members are arranged in a plurality of columns on both ends of the lens holder in the tracking direction of the optical disk.

An objective lens driver may also comprise:

a lens holder, for holding an objective lens that focuses a laser beam on an optical disk;

a first focusing coil, for moving one end of the lens holder in a focusing direction of the optical disk;

a second focusing coil, for moving one end of the lens holder in the focusing direction of the optical disk and for moving the other end in an opposite focusing direction of the optical disk;

a tracking coil assembly, for moving the lens holder in a tracking direction of the optical disk; and

flexible members including
a first flexible member pair, for feeding a current to the first focusing foil,
a second flexible member pair, for feeding a current to the second focusing coil, and
a third flexible member pair, for feeding a current to the tracking coil assembly,

wherein the lens holder is flexibly supported at a driver main body by the flexible members, and the flexible members are arranged in a plurality of columns on both ends of the lens holder in the tracking direction of the optical disk.

Since the flexible members are arranged in a plurality of rows at both ends of the lens holder in the tracking direction of the optical disk, a reduced number of rows of the flexible members can be arranged in the focusing direction of the optical disk. Therefore, the thickness of the objective lens driver can be reduced. Further, required space can be obtained for connections between the first focusing coil and the first flexible member pair, the second focusing coil and the second flexible member pair, and the tracking coil assembly and the third flexible member pair. Furthermore, required space can be obtained for connecting the first, second and third flexible member pairs to the conductive lines that feed a current to the first and second focusing coils and to the tracking coil assembly. In addition, when the flexible members, the lens holder and the flexible member are to be integrally formed, the thicknesses of spacers to be inserted into these flexible members can also be obtained.

According to the objective lens driver of the invention, a required number of flexible members are arranged, at both ends of the lens holders, in a plurality of columns in the tracking direction of the optical disk. Therefore, the number of rows to be arranged in the focusing direction of the optical disk can be reduced, and a slim type of objective lens driver can be provided. Moreover, a satisfactory number of flexible members is obtained to feed a current to the first and second focusing coils and the tracking coil assembly, and control of the inclination of the objective lens relative to the optical disk can be exercised.

### BRIEF DESCRIPTION OF THE DRAWINGS

FIG. 1 is a diagram showing the configuration of an objective lens driver according to a first embodiment of the present invention.

FIG. 2 is a diagram showing the structure of a lens holder according to the first embodiment.

FIG. 3A is a plan view of a frame member, including flexible members, according to the first embodiment; and

FIG. 3B is an enlarged diagram showing a portion A.

FIG. 4 is a diagram showing the structure of a fixing member according to the first embodiment.

FIG. 5A is a diagram showing the structure of a yoke for the first embodiment wherein magnets are located; and

FIG. 5B is a diagram showing the structure for another example.

FIG. 6A is a diagram showing the connection of focusing coils and a tracking coil assembly to the flexible members in the first embodiment, viewed from the side opposite the fixing member; and

FIG. 6B is a diagram showing the connections viewed from the fixing member side.

FIG. 7 is a diagram showing the connection of the flexible members to a conductive line according to the first embodiment, viewed from the fixing member side.

FIG. 8A is a diagram showing a flat plate for explaining a method for manufacturing the objective lens driver according to the first embodiment;

FIG. 8B is a diagram showing the state wherein the frame member has been completed;

FIG. 8C is a diagram showing the state wherein the molding of a lens holder and the fixing member has been completed;

FIG. 8D is a diagram showing the state wherein attachment of the focusing coils and the tracking coil assembly has been completed;

FIG. 8E is a diagram showing the state wherein attachment of an objective lens has been completed;

FIG. 8F is a diagram showing the state wherein cutting of the flexible members has been completed;

FIG. 8G is a diagram showing the state wherein the yoke on which the magnets are arranged has been attached; and

FIG. 8H is a diagram showing the state wherein the objective lens driver has been completed by attaching an FPC and injecting a damping gel.

FIG. 9 is a diagram showing the winding directions for a first focusing coil and a second focusing coil according to a second embodiment of the present invention.

FIG. 10A is a diagram showing the connection of the focusing coils and a tracking coil assembly to the flexible members in the second embodiment, viewed from the side opposite a fixing member; and

FIG. 10B is a diagram showing the connection viewed from the fixing member side.

FIG. 11 is a diagram showing the structure of the optical system of an optical pickup device according to a third embodiment of the present invention.

FIG. 12 is a top view of the arrangement of the optical pickup device according to the third embodiment.

FIG. 13A is a top view of the structure of an optical pickup module according to a fourth embodiment of the present invention; and

FIG. 13B is a bottom view of this structure.

FIG. 14 is a diagram showing the arrangement of an optical disk apparatus according to the fourth embodiment.

FIG. 15 is a diagram showing the objective lens driver of a conventional optical pickup device that can perform the recording and reproduction of a CD and a DVD.

FIG. 16 is a top view of an objective lens driver according to a fifth embodiment of the present invention.

FIG. 17 is a diagram showing the arrangement of flexible members for the fifth embodiment.

FIG. 18 is a graph showing a spring constant for the flexible members according to the fifth embodiment.

### DETAILED DESCRIPTION

According to a first aspect of the present invention, an objective lens driver comprises:

a lens holder, for holding an objective lens that focuses a laser beam on an optical disk;

a first focusing coil, for moving one end of the lens holder in a focusing direction of the optical disk;

a second focusing coil, for moving the other end of the lens holder in the focusing direction of the optical disk;

a tracking coil assembly, for moving the lens holder in a tracking direction of the optical disk; and

flexible members including
a first flexible member pair, for feeding a current to the first focusing foil,
a second flexible member pair, for feeding a current to the second focusing coil, and
a third flexible member pair, for feeding a current to the tracking coil assembly,

wherein the lens holder is flexibly supported at a driver main body by the flexible members, and the flexible members are arranged in a plurality of columns on both ends of the lens holder in the tracking direction of the optical disk.

According to the first aspect of the invention, a required number of flexible members are arranged, at both ends of the lens holders, in a plurality of columns in the tracking direction of the optical disk. Therefore, the number of rows to be arranged in the focusing direction of the optical disk can be reduced, and a slim type of objective lens driver can be provided. Moreover, a satisfactory number of flexible members is obtained to feed a current to the first and second focusing coils and the tracking coil assembly, and control of the inclination of the objective lens relative to the optical disk can be exercised.

According to a second aspect of the invention, an objective lens driver comprises:

a lens holder, for holding an objective lens that focuses a laser beam on an optical disk;

a first focusing coil, for moving one end of the lens holder in a focusing direction of the optical disk;

a second focusing coil, for moving one end of the lens holder in the focusing direction of the optical disk and for moving the other end in an opposite focusing direction of the optical disk;

a tracking coil assembly, for moving the lens holder in a tracking direction of the optical disk; and

flexible members including
a first flexible member pair, for feeding a current to the first focusing foil,
a second flexible member pair, for feeding a current to the second focusing coil, and
a third flexible member pair, for feeding a current to the tracking coil assembly,

wherein the lens holder is flexibly supported at a driver main body by the flexible members, and the flexible members are arranged in a plurality of columns on both ends of the lens holder in the tracking direction of the optical disk.

According to the second aspect of the invention, a required number of flexible members are arranged, at both ends of the lens holders, in a plurality of columns in the tracking direction of the optical disk. Therefore, the number of rows to be arranged in the focusing direction of the optical disk can be reduced, and a slim type of objective lens driver can be provided. Moreover, a satisfactory number of flexible members is obtained to feed a current to the first and second focusing coils and the tracking coil assembly, and control of the inclination of the objective lens relative to the optical disk can be exercised.

According to a third aspect of the invention, for the objective lens driver of the first or the second aspect, the flexible members are arranged, at both ends of the lens holder, in two columns in the tracking direction of the optical disk and in two rows for the focusing direction of the optical disk.

Since the flexible members are arranged at both ends of the lens holder in two columns in the direction of width and in two rows in the direction of the thickness, a total eight of flexible members are prepared. Thus, a satisfactory number of flexible members can be obtained to feed current to the first and second focusing coils and the tracking coil assembly, and the inclination of the objective lens can be controlled relative to the optical disk. In addition, since the flexible members are arranged in two rows in the direction of the thickness, the thin type of objective lens driver can be provided.

According to a fourth aspect of the invention, for the objective lens driver of the third aspect, the flexible members include a fourth flexible member pair that is not connected to either the first focusing coil, the second focusing coil or the tracking coil assembly.

Since the fourth flexible member pair is provided, the flexible members can be symmetrically arranged vertically and horizontally, so that the lens holder can be supported in a balanced state.

According to a fifth aspect of the invention, for the objective lens driver of the third aspect, flexible members arranged at both ends of the lens holder in columns, near the optical disk, are located substantially on the same plane.

Four flexible members can be formed in one frame member obtained by processing one flat plate, and can be integrally formed with the lens holder and the fixing member that is included in the driver main body. Thus, the manufacturing process is simplified, and only a low manufacturing expenditure is required.

According to a sixth aspect of the invention, for the objective lens driver of the third aspect, flexible members arranged, on both sides of the lens holder, in columns that are farther from the optical disk are substantially positioned on the same plane.

Four flexible members can be formed in one frame member obtained by processing one flat plate, and can be integrally formed with the lens holder and the fixing member that is included in the driver main body. Thus, the manufacturing process is simplified, and only a low manufacturing expenditure is required.

According to a seventh aspect of the invention, for the objective lens driver of the first or the second aspect, the flexible members are split near the driver main body, and one branch of each of the flexible members is fixed to the driver main body.

The flexibility of the flexible members can be optimized.

According to an eighth aspect of the invention, for the objective lens driver of the seventh aspect, at the least, the flexible members arranged in the innermost column include a bent portion, between a split position and the driver main body.

With this arrangement, the flexible force, in the tracking direction of the optical disk, of the flexible members arranged in the innermost column is reduced. Therefore, for the flexible members that support the lens holder, the flexible force exerted in the focusing direction of the optical disk is well balanced relative to the flexible force exerted in the tracking direction.

According to a ninth aspect of the invention, for the objective lens driver of the seventh aspect, flexible members nearer the driver main body than the split position are covered with a damping gel.

With this arrangement, vibrations and shocks transmitted by the fixing member to the lens holder can be reduced.

According to a tenth aspect of the invention, for the objective lens driver of the first or the second aspect, the flexible members are embedded in the lens holder.

Since the flexible members are integrally molded with the lens holder, the flexible members and the lens holder can be assembled easily.

According to an eleventh aspect of the invention, for the objective lens driver of the tenth aspect, at least a part of connections made between the first focusing coil and the first flexible member pair, between the second focusing coil and the second flexible member and between the tracking coil assembly and the third flexible member is made on the side of the lens holder opposite the driver main body.

With this arrangement, spaces for connecting the flexible members to the first and the second focusing coil and the tracking coil assembly can be easily obtained. Thus, the manufacturing process can be simplified and only a low manufacturing expenditure is required.

According to a twelfth aspect of the invention, for the objective lens driver of the first or the second aspect, the driver main body includes a fixing member for embedding the flexible members.

Since the flexible members are integrally molded with the lens holder, the flexible members and the fixing member can be assembled easily.

According to a thirteenth aspect of the invention, for the objective lens driver of the twelfth aspect, a land for a flexible print board is located on the side of the fixing member opposite the lens holder, and the first flexible member pair, the second flexible member pair and the third flexible member pair are connected to the flexible print board using the land.

With this arrangement, space for connecting the flexible members to the flexible print board can be easily obtained. Thus, the manufacturing process is simplified, and only a low manufacturing expenditure is required.

According to a fourteenth aspect of the invention, for the objective lens driver of the first or the second aspect, the driver main body includes:

a flat portion, for securing the fixing member in which the flexible members are embedded;

arm portions, extending from both ends of the flat portion, substantially in the same direction;

first upright yokes, formed by bending the flat portion between the arm portions at substantially a right angle; and

second upright yokes, formed by bending the arm portions along oblique folds, at substantially right angles, toward the same side as the first upright yokes, so that distal ends of the arm portions face the first upright yokes.

With this arrangement, since only a small space is required, it is easy for an optical pickup device to be compactly made.

According to a fifteenth aspect of the invention, for the objective lens driver of the third aspect, a gap at which the flexible members are arranged in two rows, at both ends of the lens holders, is equal to or smaller than 1 mm.

With this arrangement, the thickness of the objective lens driver can be reduced.

According to a sixteenth aspect of the invention, for the objective lens driver of the first or the second aspect, widths of the flexible members vary among a portion near the lens holder, a portion near the driver main body and the center portion.

Therefore, the flexibility is not much different from that of the flexible members, while the overall width is narrow. Thus, the flexible members can be manufactured comparatively easily using a punching press.

According to a seventeenth aspect of the invention, for the objective lens driver of the sixteenth aspect, since the widths of the flexible members are such that their center portions are wide and their portions near the lens holder and their portions near the driver main body are narrow.

Since the center portions do not influence their flexibility very much, a flexibility that does not differ much from that of a flexible member, which overall has a narrow width, can be provided. Thus, the flexible members can be comparatively easily manufactured using a punching press.

According to an eighteenth aspect of the invention, a method for manufacturing an objective lens driver comprises:

a first step of producing a first frame member, which includes four flexible members that are integrally formed with a frame and are arranged on the side near an optical disk, and a second frame member, which includes four flexible members that are integrally formed with a frame and are arranged on the side farther from the optical disk;

a second step of integrally forming a lens holder and a fixing member with the first frame member and the second frame member, with the first frame member and the second frame member being separated a predetermined distance;

a third step of fixing a first focusing coil, a second focusing coil and tracking coil assembly to the lens holder, and connecting the first focusing coil to a first flexible member pair of the eight flexible members, connecting the second focusing coil to a second flexible pair of the eight flexible members, and connecting the tracking coil assembly to a third flexible member pair of the eight flexible members;

a fourth step of locating an objective lens at a predetermined position on the lens holder; and

a fifth step of separating the flexible members from the frames by cutting.

Since the flexible members are integrally formed with the lens holder and the fixing member, the manufacturing process can be simplified, and only a low manufacturing expenditure is required.

According to a nineteenth aspect of the invention, a method for manufacturing an objective lens driver comprises:

a first step of producing a first frame member, which includes two flexible members that are integrally formed with a frame and arranged in an inner column near an optical disk, a second frame member, which includes two flexible members that are integrally formed with a frame and arranged in an outer column near the optical disk, a third frame member, which includes two flexible members that are integrally formed with a frame and arranged in an inner column farther from the optical disk, and a fourth frame member, which includes two flexible members that are integrally formed with a frame and arranged in an outer column farther from the optical disk;

a second step of integrally forming a lens holder and a fixing member with the first to the fourth frame members, while the first and second frame members, which are aligned, are separated by a predetermined distance from the third and fourth frame members, which are aligned;

a third step of fixing a first focusing coil, a second focusing coil and tracking coil assembly to the lens holder, and connecting the first focusing coil to a first flexible member pair of the eight flexible members, connecting the second focusing coil to a second flexible pair of the eight flexible members, and connecting the tracking coil assembly to a third flexible member pair of the eight flexible members;

a fourth step of locating an objective lens at a predetermined position on the lens holder; and

a fifth step of separating the flexible members from the frames by cutting.

Since the flexible members are integrally formed with the lens holder and the fixing member, the manufacturing process can be simplified, and only a low manufacturing expenditure is required.

According to a twentieth aspect of the present invention, an optical pickup device comprises an objective lens driver that includes:

a lens holder, for holding an objective lens that focuses a laser beam on an optical disk;

a first focusing coil, for moving one end of the lens holder in a focusing direction of the optical disk;

a second focusing coil, for moving the other end of the lens holder in the focusing direction of the optical disk;

a tracking coil assembly, for moving the lens holder in a tracking direction of the optical disk; and

flexible members including
a first flexible member pair, for feeding a current to the first focusing foil,
a second flexible member pair, for feeding a current to the second focusing coil, and
a third flexible member pair, for feeding a current to the tracking coil assembly,

wherein the lens holder is flexibly supported at a driver main body by the flexible members, and the flexible members are arranged in a plurality of columns on both ends of the lens holder in the tracking direction of the optical disk.

According to the twentieth aspect of the invention, a for the objective lens driver, required number of flexible members are arranged, at both ends of the lens holders, in a plurality of columns in the tracking direction of the optical disk. Therefore, the number of rows to be arranged in the focusing direction of the optical disk can be reduced, and a slim type of objective lens driver can be provided. Moreover, a satisfactory number of flexible members is obtained to feed a current to the first and second focusing coils and the tracking coil assembly, and control of the inclination of the objective lens relative to the optical disk can be exercised. As a result, the optical pickup device can cope with recording and reproduction of both CDs and DVDs.

According to a twenty-first aspect of the invention, an optical pickup device comprises an objective lens driver that includes:

a lens holder, for holding an objective lens that focuses a laser beam on an optical disk;

a first focusing coil, for moving one end of the lens holder in a focusing direction of the optical disk;

a second focusing coil, for moving one end of the lens holder in the focusing direction of the optical disk and for moving the other end in an opposite focusing direction of the optical disk;

a tracking coil assembly, for moving the lens holder in a tracking direction of the optical disk; and

flexible members including
a first flexible member pair, for feeding a current to the first focusing foil,
a second flexible member pair, for feeding a current to the second focusing coil, and
a third flexible member pair, for feeding a current to the tracking coil assembly,

wherein the lens holder is flexibly supported at a driver main body by the flexible members, and the flexible members are arranged in a plurality of columns on both ends of the lens holder in the tracking direction of the optical disk.

According to the twenty-first aspect of the invention, a for the objective lens driver, required number of flexible members are arranged, at both ends of the lens holders, in a plurality of columns in the tracking direction of the optical disk. Therefore, the number of rows to be arranged in the focusing direction of the optical disk can be reduced, and a slim type of objective lens driver can be provided. Moreover, a satisfactory number of flexible members is obtained to feed a current to the first and second focusing coils and the tracking coil assembly, and control of the inclination of the objective lens relative to the optical disk can be exercised. As a result, the optical pickup device can cope with recording and reproduction of both CDs and DVDs.

According to a twenty-second aspect of the present invention, an optical disk apparatus comprises an objective lens driver that includes:

a lens holder, for holding an objective lens that focuses a laser beam on an optical disk;

a first focusing coil, for moving one end of the lens holder in a focusing direction of the optical disk;

a second focusing coil, for moving the other end of the lens holder in the focusing direction of the optical disk;

a tracking coil assembly, for moving the lens holder in a tracking direction of the optical disk; and

flexible members including
a first flexible member pair, for feeding a current to the first focusing foil,
a second flexible member pair, for feeding a current to the second focusing coil, and
a third flexible member pair, for feeding a current to the tracking coil assembly,

wherein the lens holder is flexibly supported at a driver main body by the flexible members, and the flexible members are arranged in a plurality of columns on both ends of the lens holder in the tracking direction of the optical disk.

According to the twenty-second aspect of the invention, a for the objective lens driver, required number of flexible members are arranged, at both ends of the lens holders, in a plurality of columns in the tracking direction of the optical disk. Therefore, the number of rows to be arranged in the focusing direction of the optical disk can be reduced, and a slim type of objective lens driver can be provided. Moreover, a satisfactory number of flexible members is obtained to feed a current to the first and second focusing coils and the tracking coil assembly, and control of the inclination of the objective lens relative to the optical disk can be exercised. As a result, the optical pickup device can cope with recording and reproduction of both CDs and DVDs.

According to a twenty-third aspect of the invention, an optical disk apparatus comprises an objective lens driver that includes:

a lens holder, for holding an objective lens that focuses a laser beam on an optical disk;

a first focusing coil, for moving one end of the lens holder in a focusing direction of the optical disk;

a second focusing coil, for moving one end of the lens holder in the focusing direction of the optical disk and for moving the other end in an opposite focusing direction of the optical disk;

a tracking coil assembly, for moving the lens holder in a tracking direction of the optical disk; and

flexible members including
a first flexible member pair, for feeding a current to the first focusing foil,
a second flexible member pair, for feeding a current to the second focusing coil, and
a third flexible member pair, for feeding a current to the tracking coil assembly,

wherein the lens holder is flexibly supported at a driver main body by the flexible members, and the flexible members are arranged in a plurality of columns on both ends of the lens holder in the tracking direction of the optical disk.

According to the twenty-third aspect of the invention, a for the objective lens driver, required number of flexible members are arranged, at both ends of the lens holders, in a plurality of columns in the tracking direction of the optical disk. Therefore, the number of rows to be arranged in the focusing direction of the optical disk can be reduced, and a slim type of objective lens driver can be provided. Moreover, a satisfactory number of flexible members is obtained to feed a current to the first and second focusing coils and the tracking coil assembly, and control of the inclination of the objective lens relative to the optical disk can be exercised. As a result, the optical pickup device can cope with recording and reproduction of both CDs and DVDs.

According to a twenty-fourth aspect of the invention, for the objective lens driver of the first or the second aspect, a ratio of a distance, on the lens holder side, between a flexible member located in the innermost column and a flexible member located in the outermost column, relative to a distance between the two on the driver main body side, is substantially equal to a ratio of a distance, on the lens holder side, between the flexible members located at both ends of the lens holder, relative to a distance for the two on the driver main body side.

Since the spring constant in the tracking direction can be reduced until substantially equal to the spring constant in the focusing direction, the flexibility is well balanced in the tracking direction and in the focusing direction.

According to a twenty-fifth direction of the invention, the objective lens driver of the first or the second aspect, the distance, on the driver main body side, of the flexible members located at both ends of the lens holder is equal to or shorter than a distance on the lens holder side.

Since the objective lens, the first and the second focusing lenses and the tracking coil assembly are provided for the lens holder, the width on the lens holder side tends to be increased. When the distance on the driver main body side is shortened, the weight and size of the objective lens driver can still further be reduced.

According to a twenty-sixth aspect of the invention, for the objective lens driver of the twenty-fifth aspect, the distance on the driver main body side between the-flexible member located in the innermost column-and the flexible member located in the outermost column is equal to or smaller than the distance on the lens holder side.

Since the spring constant in the tracking direction can be reduced, the flexibility is well balanced in the tracking direction and in the focusing direction.

According to a twenty-seventh aspect of the invention, for the objective lens driver of the first or the second aspect, the flexible members include at least one refraction point, and adjacent flexible members arranged in the same row are substantially parallel between the lens holder and the refraction point and between the refraction point and the driver main body.

In manufacturing a flexible member by using press forming, the distance between the flexible members corresponds to a draft distance. And since the adjacent flexible members are arranged so they are parallel, a large draft distance can be obtained. Therefore, the flexible members can be easily produced.

According to a twenty-eighth aspect of the invention, for the objective lens driver of the twenty-seventh aspect, when the flexible members have a plurality of refraction points, adjacent flexible members arranged in the same row are substantially parallel between the individual refraction points.

With this arrangement, the flexible members can be extracted almost at a right angle, relative to the lens holder and the driver main body. Thus, the flexibility is stabilized.

According to a twenty-ninth aspect of the invention, for the objective lens driver of the seventh aspect, as for the flexible member arranged in the innermost column, an outward branch is fixed to the driver main body, and as for the flexible member arranged in the outermost column, an inward branch is fixed to the driver main body.

With this arrangement, a small distance can be maintained for the flexible member arranged in the innermost column and the flexible member arranged in the outermost column on the driver main body side.

### First Embodiment

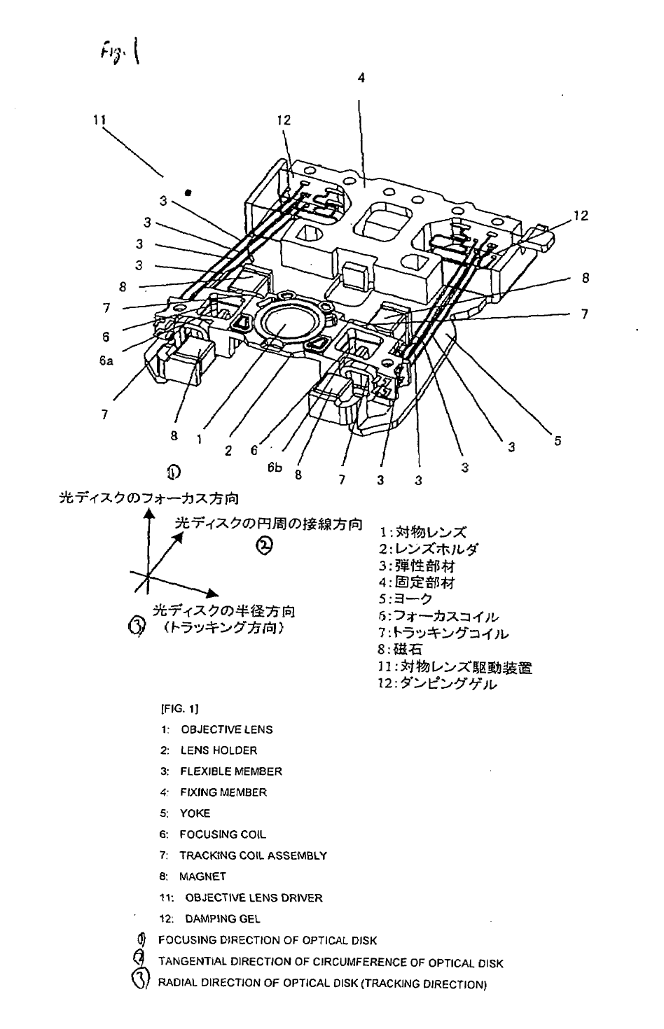

A first embodiment of the present invention will now be described while referring to drawings. FIG. 1 is a diagram showing the configuration of an objective lens driver according to the first embodiment. In an objective lens driver 11 for the first embodiment, an objective lens 1, focusing coils 6 and a tracking coil assembly 7 are fixed at predetermined locations on a lens holder 2. Further, a fixing member 4 is fixed to a yoke 5, to which magnets 8 are secured, and this assembly is called a driver main body. One end each of individual flexible members 3 is fixed to the lens holder 2 and the other end is fixed to the fixing member 4. The lens holder 2 is supported by the flexible members 3. These flexible members 3 are arranged in multiple columns at both ends of the lens holder 2, and in this embodiment, the flexible members 3 are arranged in two columns and in two rows. When six flexible members 3 are required for connection to the focusing coils 6 and the tracking coil assembly 7 that are employed, an arrangement of three columns in one row is the smallest, appropriate arrangement. However, since the arrangement of three columns in one row tends to increase the width of the objective lens driver, in this embodiment, the flexible members 3 are arranged in two columns of two rows, and at this time, eight flexible members 3 are employed. Furthermore, in this embodiment, the array of the flexible members 3 arranged in the tracking direction of an optical disk is called a column, and the array in the focusing direction of the optical disk is called a row. That is, the column is in the direction of the width of the objective lens driver 11, and the row is in the direction of the thickness of the objective lens driver 11. When multiple rows of the flexible members 3 are arranged, the array near the objective lens 1 is called an inner row and the array farther from the objective lens 1 is called an outer row. When two rows of the flexible members 3 are arranged, the row near an optical disk is called a top row, and the row farther from the optical disk is called a bottom row.

In this embodiment, the gap between the flexible members 3 on the top and bottom rows is defined as 0.6 mm. When the gap is equal to or smaller than 1 mm, the thickness of the objective lens driver can be reduced much more than that of the conventional configuration. When the gap is 0.8 mm, it is assumed that the space required for the connection of the flexible members 3 to the focusing coils 6 and the tracking coil assembly 7 and the space for the connection of the flexible members 3 to conductive lines for feeding a current to the focusing coils 6 and the tracking coil assembly 7 can be satisfactorily obtained. Further, when the flexible members 3, the lens holder 2 and the fixing member 4 are to be integrally formed, the thicknesses of spacers to be inserted into these flexible members 3 can also be appropriately obtained. When the gap between the top and the bottom flexible members 3 is 0.6 mm, this is almost equal to the gap between the flexible members in the conventional configuration, and the space required for the connection of the flexible members 3 to the focusing coils 6 and the tracking coil assembly 7 and the space required for the connection of the flexible members 3 to conductive lines for feeding a current to the focusing coils 6 and the tracking lines 7 can be obtained, although there is not any surplus. Further, when the flexible members 3, the lens holder 2 and the fixing member 4 are to be integrally formed, the thicknesses of the spacers to be inserted into the flexible members 3 can be obtained, although there is not any surplus. As a result, the objective lens driver 11 can be made as thin as possible.

The arrangement of the objective lens driver 11 will now be described. The objective lens 1 is a lens that condenses a laser beam emitted by a laser source (not shown) so as to focus the laser beam on the recording face of an optical disk (not shown). The objective lens 1 is a bifocal lens that has different focal points for a CD and a DVD. The objective lens 1 is made of optical glass or optical plastic, and is fixed to the lens holder 2.

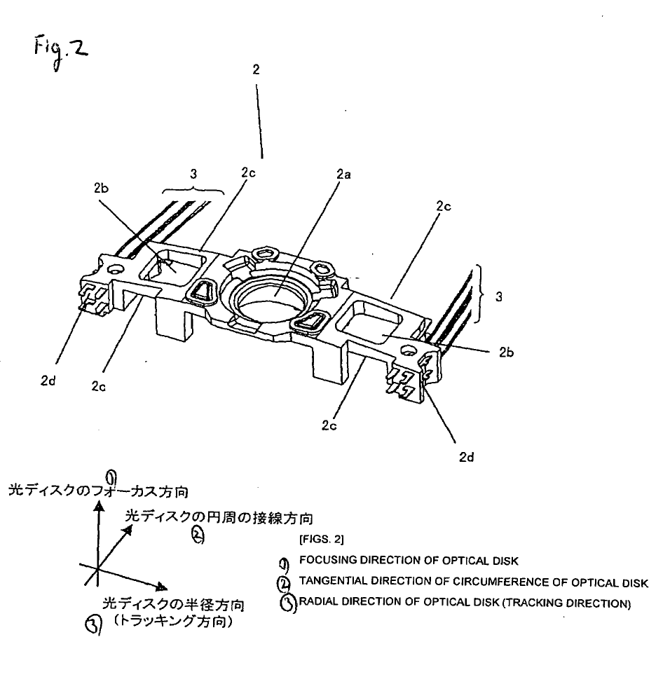

FIG. 2 is a diagram showing the arrangement of the lens holder 2 for the first embodiment. Since the flexible members 3 are integrally formed with the lens holder 2, which will be described later, the flexible members 3 are also shown in FIG. 2. A first through hole 2a, where the objective lens 1 is to be fitted in the top, is formed in the center of the lens holder 2, and second through holes 2b, into which the focusing coils 6 are to be fitted, are formed, one on each side of the first through hole 2a, and are arranged substantially in the tracking direction of the optical disk. Further, formed in the outer edge and partially overlapping the second through holes 2b are notches 2c, into which the tracking coil assembly 7 is to be fitted. Furthermore, projected portions 2d, for holding the flexible members 3, are formed in the side faces at the ends of the lens holder 2, almost in the tracking direction of the optical disk.

The lens holder 2 is made, for example, of a liquid crystal polymer with a glass filler, an insulating material, since as will be described later, the flexible members 3 are electrically insulated from the projected portions 2d. At each of the projected portions 2d, in the side faces at the ends of the lens holder 2, four flexible members 3 are arranged to form an inner and an outer column and a top and a bottom row.

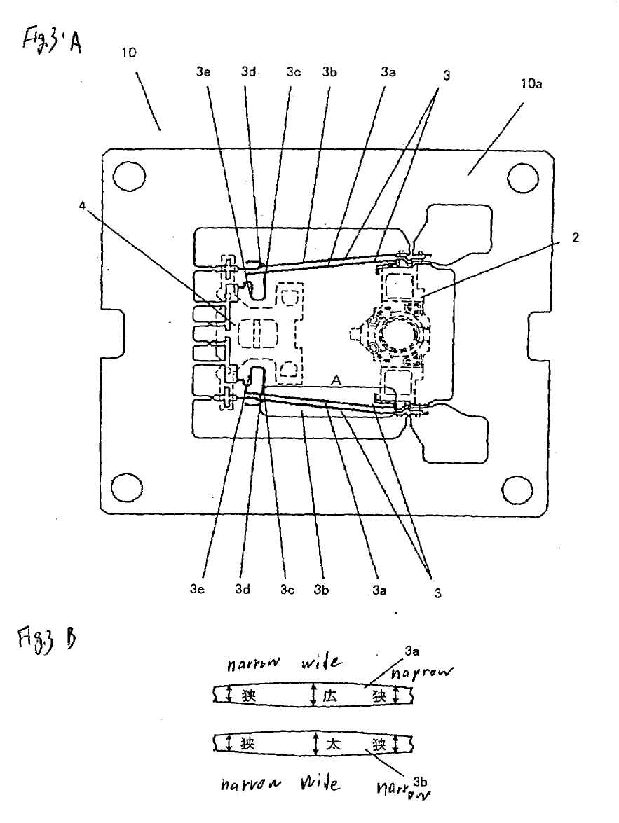

FIG. 3A is a plan view of a frame member including the flexible members 3 according to the first embodiment, and FIG. 3B is an enlarged schematic diagram showing a portion A. As shown in FIG. 3A, in the first embodiment, the flexible members 3 are produced by cutting a flat plate using, for example, a punch press, and are enclosed by a frame 10a. This is called a frame member 10. In this embodiment, the thickness of a flexible member 3, i.e., the thickness of the frame member 10, is 0.05 mm. However, the thicknesses that can be used are not thereby limited, and while taking flexibility and mechanical strength into account, a thickness ranging from about 0.025 mm to 0.10 mm should be selected. Note further, that in cross section, the shape of a flexible member 3 is a flat plate.

Note also that for both an inner flexible member 3a and an outer flexible member 3b, as shown in FIG. 3B, the widths, i.e., 0.09 mm, of the center portions are broader than are the widths, i.e., 0.07 mm, of the portions near the lens holder 2 and the fixing member 4, the driver main body, because when a manufacturing process is used that involves the use of a punch press, a greater width more readily ensures accuracy in size and uniformity in cross section. However, since a reduced width is an imperative when flexibility is an included design prerequisite, to provide a flexible member that can be comparatively easily manufactured, only the size of a center portion is increased, which has less affect on flexibility, in order to produce a member having almost the same flexibility as one having a constant, narrow width. In this embodiment, the center portion of the flexible member 3 is wide, which is different from the portions near the lens holder 2 and the fixing member 4. However, the design is not limited to this one and other designs can be employed so long as both the flexibility required for the flexible member 3 and ease of manufacturing can be obtained. For example, the portion near the fixing member 4 and the center portion may be wide, and the portion near the lens holder 2 may be narrow, or the portion near the fixing member 4 may be wider than the center portion. Either one of these, or the portion near the lens holder 2 and the portion near the fixing member 4 may be narrower than the center portion 2 but have different widths. Further, as will be described later, the flexible members 3 of this embodiment have branches 3c and 3d near the fixing member 4. The above explanation for the widths used for the flexible member 3 is applied for the portion of the flexible member 3 extending between the branch 3c or 3d and the lens holder 2. When the branches 3c and 3d are not present, the explanation above may be applied for the width of the flexible member 3 extending between the flexible member 4 and the lens holder 2.

As will be described later, the flexible members 3 are integrally formed with the lens holder 2 and the fixing member 4, and are then separated from the frame 10a. In this embodiment, the flexible members 3 are shaped like a flat plate in cross section; however, the flexible members 3 may be formed of wire and circular in cross section. The flexible members 3, i.e., the frame member 10, are formed of a flexible conductive material, such as iron alloys or copper alloys (e.g., copper-beryllium alloys). In the first embodiment, the flexible members 3 arranged in the top row and the flexible members 3 arranged in the bottom row have the same shape. However, optimal shapes may be used when these flexible members 3 are formed. Further, different shapes may be employed for the flexible members 3a arranged in the inner columns and the flexible members 3b arranged in the outer columns; however, in accordance with the design, the same shape may be employed. Furthermore, although, as has been explained, the flexible members 3 on both side faces of the lens holder 2 are symmetrically shaped, since these faces correspond to the inside and outside in the radial direction of the optical disk, the flexible members 3, in accordance with the design, may have different shapes. As will be described later, one end of each flexible member 3 is embedded in the lens holder 2, and the other end is embedded in the fixing member 4.

For both the flexible members 3a in the inner columns and the flexible members 3b in the outer columns, their ends, which are to be embedded in the lens holder 2 and the fixing member 4, are widened. This is done because, as will be described later, when the flexible members 3 are embedded in the lens holder 2 and the fixing member 4, the strength required for the embedding is supplied by these ends, and because, by using these wider ends, the flexible members 3 can be easily connected to the focusing coils 6, the tracking coil assembly 7 and the conductive lines. Further, the flexible members 3 have the branches 3c and 3d, which are near the fixing member 4, but only one of the branches 3c and 3d is secured to the fixing member 4. The branches 3c and 3d are provided because they can be used to adjust the flexibility of the individual flexible members 3. Further, bent portions 3e are provided nearer the fixing member 4 than the branches 3c of the inner flexible members 3a. The bent portions 3e are formed and bent inward at the branches 3c, thereafter they are bent outward and inward again, and then, are finally bent so that they are extended parallel, in the direction leading from the lens holder 2 to the position of the branch 3c. Since the bent portions 3e are so formed, the flexible force exerted by each of the inner flexible members 3a, in the tracking direction of the optical disk, is reduced. Thus, the flexible force in the focusing direction of the optical disk and the flexible force in the tracking direction, exerted by the flexible members 3 that support the lens holder 2, can be balanced well. When flexible members 3 are arranged in three or more columns, the bent portions 3e are at least formed for the flexible members 3a arranged in the innermost column.

The flexible members 3 may not always be shaped as described above, and another optimal shape may be designed for a system that at some time is currently employed.

FIG. 4 is a diagram showing the structure of the fixing member 4 for the first embodiment. Since the fixing member 4, as well as the lens holder 2, is integrally formed with the flexible members 3, the flexible members 3 are also shown in FIG. 4. In order to hold the flexible members 3 using electric insulation, the fixing member 4 is also formed, for example, of a liquid crystal polymer containing a glass filler, an insulating material. The fixing member 4 includes holding portions 4a for accepting the flexible members 3 and notches 4b for storing the bent portions 3e of the inner flexible members 3a.

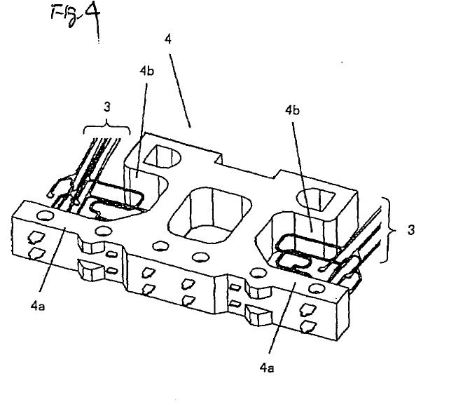

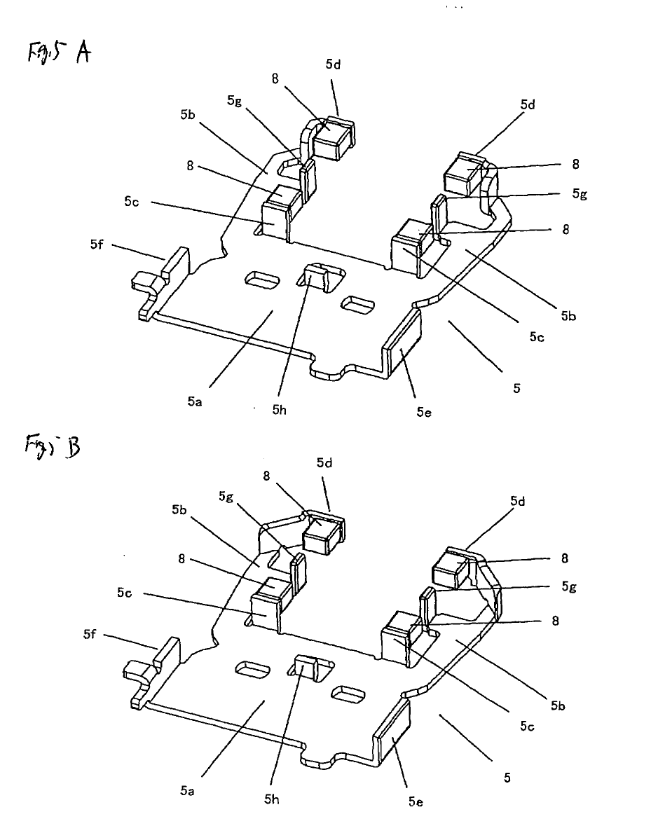

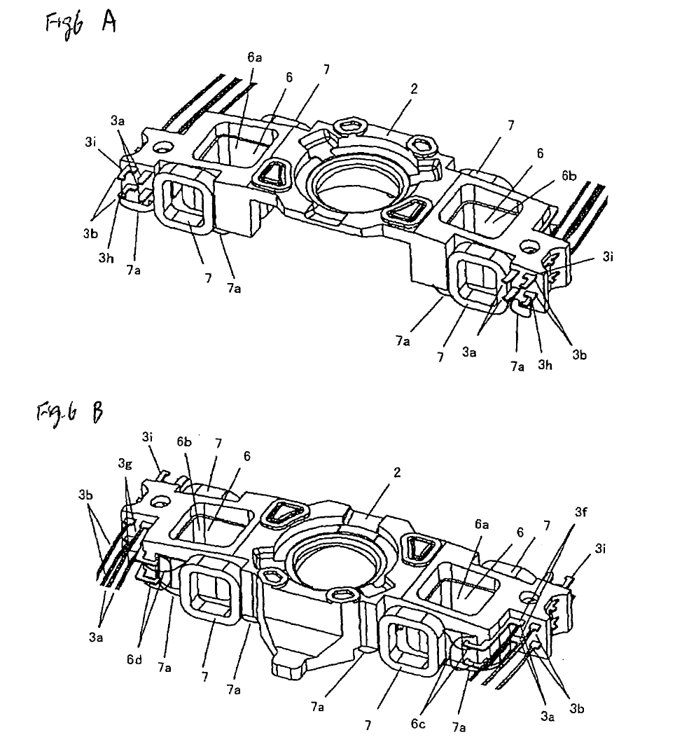

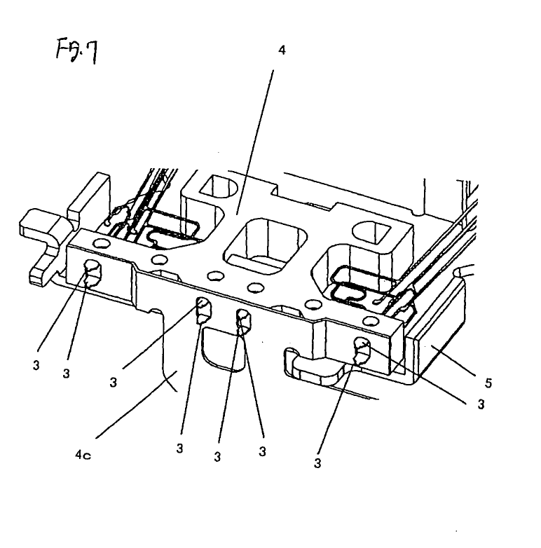

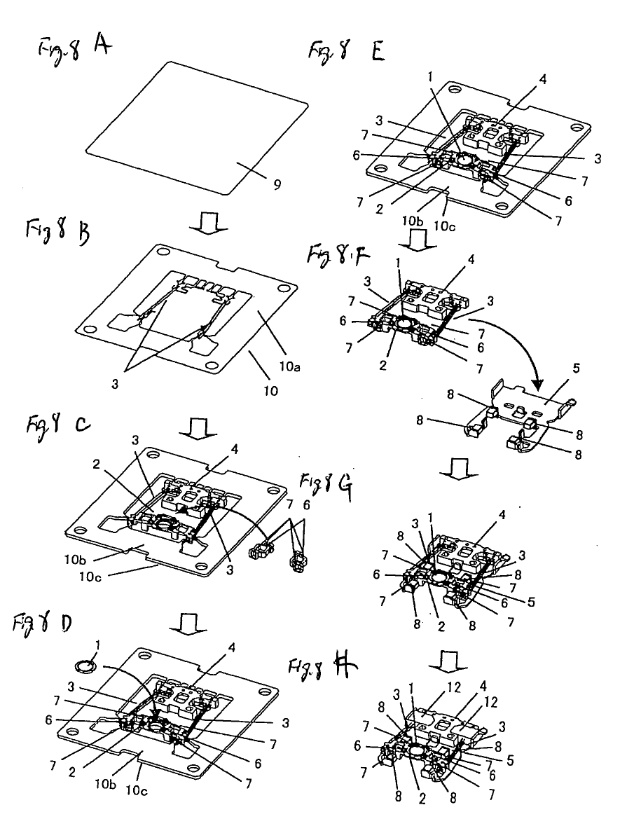

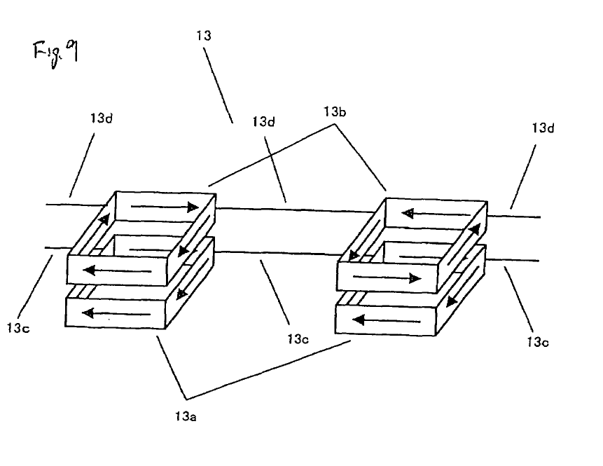

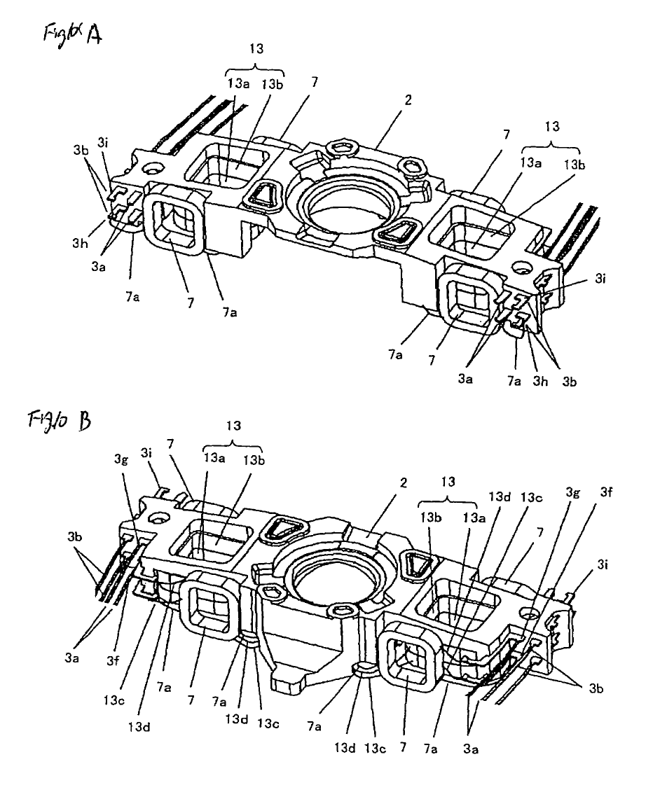

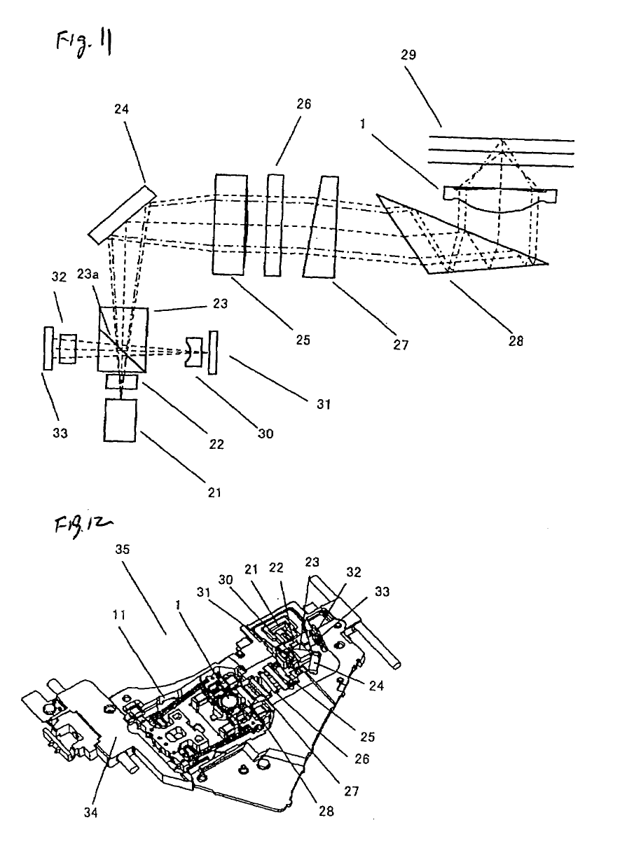

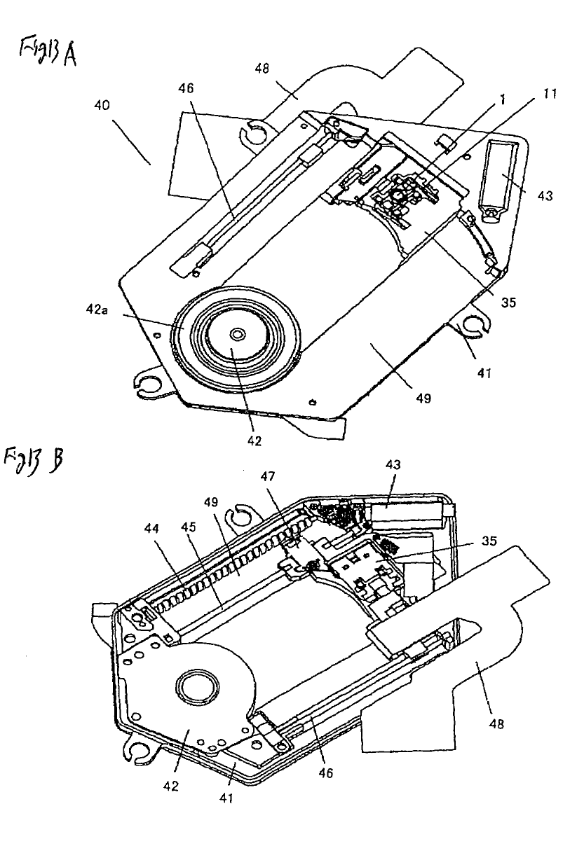

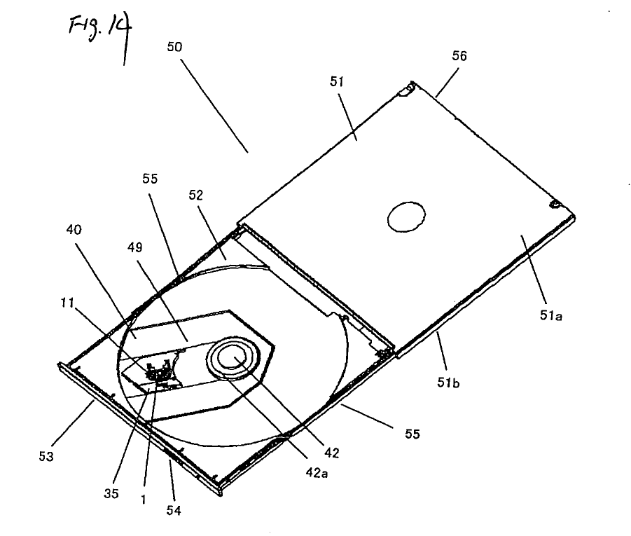

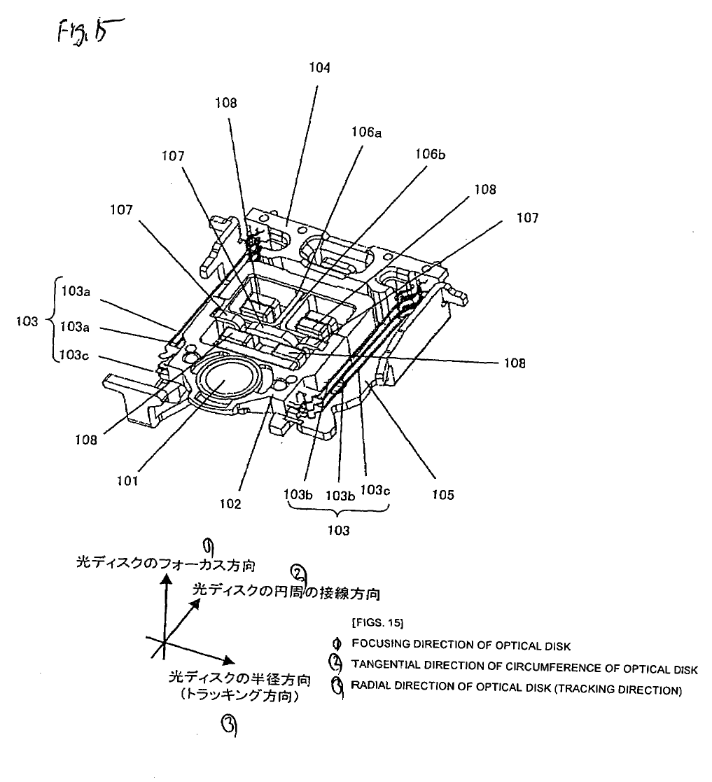

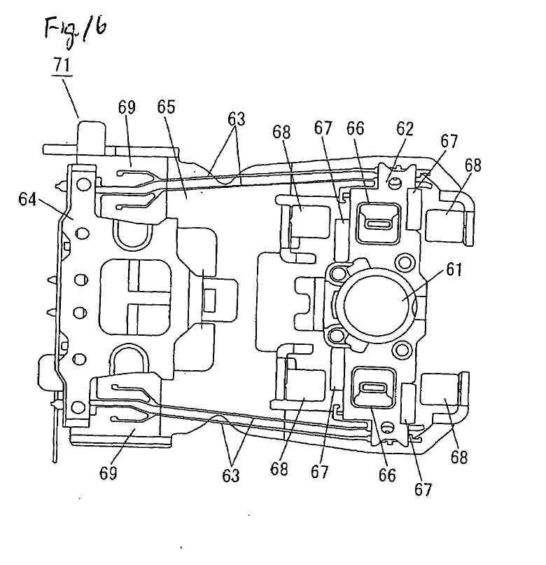

FIG. 5A is a diagram showing the structure of the yoke 5 for the first embodiment, wherein magnets are arranged, and FIG. 5B is a diagram showing another example structure. The yoke 5 is made of a magnetic material, such as iron alloys, and as shown by the structure of the yoke 5 in FIG. 5A, arms 5b are extended, in almost the same direction, from both ends of a flat portion 5a, to which the fixing member 4 is to be secured, to the end whereat the lens holder 2 is to be arranged. Two first upright yoke portions 5c, two second upright yoke portions 5d, side upright portions 5e and 5f and upright portions 5g and 5h, all of which are bent in the same direction, are located on respective sides: The first upright yokes 5c are formed by bending, at almost a right angle, the arms 5a immediately inside the flat portion 5a from which the arms 5b are extended. The second upright yokes 5d are formed by bending, almost at a right angle, the inwardly bent portions of the arms 5b so that they oppose each other, and by the further bending of the ends of the resultant arms 5b so that they face the first upright yokes 5c. The upright side portions 5e and 5f are formed by bending the sides of the flat portion 5a until they face each other. The upright portions 5g are formed by bending the portions of the arms 5b extending inward between the first upright yokes 5c and the second upright yokes 5d so that the inner surfaces of the arms 5b face each other. The upright portion 5h is formed by bending the center portion of the flat plate 5a in the same direction in which the first upright yokes 5c are bent. In this embodiment, two first upright yokes 5c are prepared; however, depending on the design employed, one or three or more first upright yokes 5c may be formed.

While referring to another example structure in FIG. 5B, second upright yokes 5d are formed by bending the arms 5b along oblique folds and thus raise them at a right angle, and to further bend the distal ends so that they face the first upright yokes 5c. According to this structure, the space required is reduced. Furthermore, the arms 5b may also be bent inward, at a right angle, and into an L shape. With this structure, only one bent position is required; however, the space needed for the structure shown in FIG. 5A, or 5B, is smaller.

The magnets 8 are permanent magnets, and are bonded, using an anaerobic adhesive, an ultraviolet curing adhesive or a thermosetting adhesive, to the faces of the first and second upright yokes 5c and 5d, located opposite each other. The magnets 8 are arranged so they face the tracking coil assembly 7, at slightly shifted positions.

FIG. 6A is a diagram showing connections for the focusing coils 6 and the tracking coil assembly 7 to the flexible members 3 of the first embodiment, as viewed from the side opposite the fixing member 4, and FIG. 6B is a diagram showing these connections as viewed from the fixing member 4. Coated conductive lines, formed of copper or copper alloys, are wound around the focusing coils 6, which comprise a first focusing coil 6a and a second focusing coil 6b, that are respectively positioned and fixed in the lens holder 2 through the application of a thermosetting adhesive or an ultraviolet adhesive, for example, around the lower edges of the second through holes 2b. In this embodiment, the ends of a lead line 6c are wound round, guided from the first focus coil 6a to joints leading from the inner flexible members 3a, located on the same side, and secured by soldering. The pair of flexible members 3 connected to the first focusing coil 6a is called a first flexible member pair 3f. Further, the ends of a lead line 6d are wound round, guided from the second focus coil 6b to joints leading from the inner flexible members 3a on the same side, and secured by soldering. The pair of flexible members 3 connected to the second focusing coil 6b is called a second flexible member pair 3g. In this embodiment, independent winding wires are employed for the first focusing coil 6a and the second focusing coil 6b; however, no limitation is placed on the coils that can be used. Like the tracking coil assembly 7 that will be described later, a plurality of winding wires may be formed by using a single, coated conductive line. Further, a plurality of winding wires may be coupled to form coils. Additionally, in this embodiment, two focusing coils 6, i.e., the first and the second focusing coils 6a and 6b, are employed. Since a maximum of four *coils, including the tracking coil assembly 7, can be connected to the flexible members 3 of this embodiment, three focusing coils 6 may be employed.

Coated conductive lines made of copper or copper alloys are wound around the tracking coil assembly 7. In this embodiment, the coils of the tracking coil assembly 7 are provided by forming four winding wires using the same conductive line, and are to be fixed to the notches 2c of the lens holder 2 using, for example, a thermosetting adhesive or an ultraviolet curing adhesive. The tracking coil assembly 7 fitted in the notches 2c is connected to the lead lines 7a, and the ends of the lead lines 7a for the tracking coil assembly 7 are wound with the ends of the outer flexible members 3b in the bottom row that are connected to the focusing coils 6, and are secured by soldering. The pair of the flexible members 3 connected to the tracking coil assembly 7 is called a third flexible member pair 3h. Four wires are employed to form the tracking coil assembly 7 in this embodiment; however, a different number of winding wires may be employed. Further, in this embodiment, one tracking coil assembly is employed; however, since the maximum four coils including the focusing coils 6 can be connected to the flexible members 3 in this embodiment, two tracking coil assemblies 7 may be employed. Among the flexible members 3, there is a fourth flexible member pair 3i that are not connected to either the first focusing coil 6a, the second focusing coil 6b or the tracking coil assembly 7. The fourth flexible member pair 3i are the outer flexible members 3b arranged on the top row. When the total eight flexible members 3, including the fourth pair 3i, are employed, the flexible members 3 can be arranged vertically and horizontally symmetrically, and the lens holder 2 can be supported well-balanced.

In the first embodiment, the first flexible members 3f and the second flexible members 3g are defined as the inner flexible members 3a, the third flexible members 3h are defined as the outer flexible members 3b in the bottom row, and the fourth flexible members 3i are defined as the outer flexible members 3b in the top row. However, no limitation is placed on the arrangements that can be used. While taking into account working efficiency and the wiring of the lead lines 6c, 6d and 7a, an arrangement for the first flexible member pair 3f, the second flexible member pair 3g, the third flexible member pair 3h and the fourth flexible member pair 3i may be determined.

Further, instead of providing the fourth flexible member pair 3i, the tracking coil assembly 7 may be connected to two third flexible member pairs 3h. That is, the lead line 7a near the winding wire may be connected to one pair of the third flexible members 3h, and the lead line 7a at the distal end may be connected to the other pair of the third flexible members 3h. By using the two pairs of third flexible members 3h, the electric resistances of the third flexible members 3h can be reduced by half. Thus, a large drive current can be fed to the tracking coil assembly 7, and the sensitivity of the objective lens driver 11 can be improved. In this embodiment, it is not preferable for two pairs of flexible members 3 to be employed as connections for the first focusing coil 6a or the second focusing coil 6b, because in this case, balance is destroyed. However, when three or more columns of the flexible members 3 are arranged at both ends of the lens holder 2, two first flexible member pairs 3f and two second flexible member pairs 3g may be employed.

As described above, when the focusing coils 6 and the tracking coil assembly 7 are connected to the flexible members 3, at least a part is located on the opposite side of the fixing member 4. Thus, since space for performing connections is obtained, the manufacturing process is simplified, and the manufacturing costs can be reduced.

FIG. 7 is a diagram showing the connection, according to the first embodiment, of the flexible members 3 and conductive lines on the fixing member 4 side. The fixing member 4 is formed of an insulating material, and the ends of the flexible members 3 are embedded therein. That is, the fixing member 4 flexibly cantilevers the lens holder 2, via the flexible members 3, so that the lens holder 2 can be displaced. An FPC (Flexible Printed Circuit) 4c that serves as a conductive line is attached to or provided near the fixing member 4 opposite the lens holder 2. A through hole and a land surrounding the through hole are formed for the FPC 4c. The flexible members 3 are passed through the through hole and are soldered to the land, so as to electrically connect the FPC 4c and the flexible members 3. And the fixing member 4 is secured to the yoke 5. Since the FPC 4c is located near the fixing member 4 opposite the lens holder 2, space for performing connections is obtained, so that the manufacturing process can be simplified and the manufacturing costs can be reduced.

Further, as shown in FIG. 1, the flexible members 3 nearer the fixing member 4 than the branches 3c and 3d are covered with a damping gel 12. The damping gel 12 is a silicon resin or an acrylic resin used for reducing vibration or shocks transmitted from the fixing member 4 to the lens holder 2.

In the first embodiment, the flexible members 3 on both ends of the lens holder 2 have been arranged in two columns and in two rows. When nine or more flexible members 3 must be arranged, the number of columns may be increased, for example, to three columns by two rows. It is not preferable for the number of rows to be increased because this would increase the thickness of the objective lens driver 11. However, so long as no restriction is placed on the thickness of the objective lens driver 11, the number of rows may be increased to three or more. On the other hand, when the number of rows is reduced to one, an objective lens driver 11 can be produced that is very thin, and thus, either three columns by one row may be employed, or an arrangement including more columns may be used. A situation wherein nine or more flexible members 3 are required is, for example, applied when focus control or tracking control accuracy is to be improved by increasing the number of focusing coils 6 or tracking coil assemblies 7. Further, the conditions in this situation are also applied when a cooling device is mounted on the lens holder 2 to prevent a temperature rise due to heat generated by the focusing coils 6 or the tracking coil assembly 7.

The manufacturing method will now be described. FIG. 8A is a diagram showing a flat plate used for the manufacturing method employed for the objective lens driver 11 of the first embodiment. FIG. 8B is a diagram showing the state wherein the frame member is completed. FIG. 8C is a diagram showing the state wherein the molding of the lens holder 2 and the fixing member 4 is completed. FIG. 8D is a diagram showing the state wherein the attachment of the focusing coils 6 and the tracking coil assembly 7 has been completed. FIG. 8E is a diagram showing the state wherein the attachment of the objective lens 1 has been completed. FIG. 8F is a diagram showing the state wherein the cutting of the flexible members 3 has been completed. FIG. 8G is a diagram showing the state wherein the yoke 5, on which the magnets 8 have been arranged, has been attached. And FIG. 8H is a diagram showing the state wherein the objective lens driver 11 has been completed after the FPC has been attached and the damping gel has been injected.

First, a flat plate 9 composed of a flexible conductive material, which is used for the flexible members 3, is processed, for example, by a punch press to provide the frame member 10 that includes the frame 10a and the flexible members 3 contiguous with the frame 10a. As the frame members 10, a first frame member 10b, which includes in the top row four flexible members 3, and a second frame member 10c, which includes in the bottom row four flexible members 3, are prepared. As described above, the first frame member 10b and the second frame member 10c may either have the same shape or different shapes. The first frame member 10b and the second frame member 10c are aligned, with a spacer (not shown) positioned between them, and the lens holder 2 and the fixing member 4 are molded. At this time, the ends of the flexible members 3 are embedded in the projecting portions 2d of the lens holder 2 and in the holding portions 4a of the fixing member 4. Sequentially, thereafter, the focusing coils 6, which are the first and the second focusing coils 6a and 6b, and the tracking coil assembly 7 are fixed, at predetermined positions, to the lens holder 2. Following this, the ends of the lead lines 6c of the first focusing coil 6a are connected to the ends of the first flexible member pair 3f, the ends of the lead lines 6d of the second focusing coil 6b are connected to the ends of the second flexible member pair 3g, and the ends of the lead lines 7a of the tracking coil assembly 7 are connected to the ends of the third flexible member pair 3h. No line is connected to the fourth flexible member pair 3i. And next, the object lens 1 is fixed, at a predetermined position, to the lens holder 2, and the flexible members 3 of the first frame member 10b and of the second frame member 10c are cut and separated from the frame 10a. For this cutting, a punch press, for example, may be employed, or the emission of a laser beam may be used. Thereafter, the fixing member 4 is secured to the yoke 5, whereon the magnets 8 are fixed in advance at predetermined positions on the first upright yoke portions 5c and the second upright yoke portions 5d. Finally, the FPC 4a is attached and connected to the flexible members 3, and the damping gel 12 is injected around the periphery of the flexible members 3 near the fixing member 4. In this manner, the objective lens driver 11 can be completed.

The method whereby the frame members 10 are produced and are integrally formed with the lens holder 2 and the fixing member 4 can simplify the manufacturing process, and thus reduce the manufacturing costs.

According to this embodiment, the frame members 10 are the first frame member 10b and the second frame member 10c, which include four flexible members 3 each. However, the frame members 10 may instead include: a first frame member 10d, which includes inner flexible members 3a in the top row; a second frame member 10e, which includes outer flexible members 3b in the top row; a third frame member 10f, which includes inner flexible members 3 in the bottom row; and a fourth frame members 10g, which includes the outer flexible members 3 in the bottom row. In this case, when the lens holder 2 and the fixing member 4 are to be molded, the first frame member 10d and the second frame member 10e are aligned, with almost no intervening gap, and the third frame member 10f and the fourth frame member 10g are aligned, with almost no intervening gap, and a spacer is inserted between these two assemblies. Either this, or two frame members 10 may be formed, each of which is constituted by an upper frame member 10 that includes four flexible members 3 and a lower frame member 10 that includes two flexible members 3, and these two frame members 10 aligned. Or an inverted structure may be employed.

Furthermore, in order to arrange the flexible members 3 into three or more columns, the first frame member 10b and the second frame member 10c, each of which include six or more flexible members 3, may be prepared. Or three or more frame members 10, which include two flexible members 3, may be aligned to provide an upper frame member 10, and the same number of frame members 10 may be aligned to provide a lower frame member 10. Or a frame member 10 that includes four flexible members 3 and a frame member 10 that includes two flexible members 3 may be assembled for use.

When the objective lens 1 mounted on the lens holder 2 is to be moved in the focusing direction of the optical disk, a current should be fed either to the first focusing coil 6a, at least, or the second focusing coil 6b. To feed power to the first focusing coil 6a, a drive current is supplied from the FPC 4c and the first flexible member 3f to the first focusing coil 6a, and is returned, through the other first flexible member 3f, to the FPC 4c. To feed power to the second focusing coil 6b, a drive current is transmitted from the FPC 4c and the second flexible member 3g to the second focusing coil 6b, and is returned, through the other second flexible member 3g, to the FPC 4c. Then, in accordance with a current flowing through the first or the second focusing coil 6a or 6b, an electromagnetic force is generated by the magnetic field of the magnets 8, and the objective lens 1 is moved in the focusing direction. When a drive current to be supplied is changed between the first focusing coil 6a and the second focusing coil 6b, a different electromagnetic force is exerted by each coil, and accordingly, the distance to the objective lens 1 in the focusing direction is also changed. In this manner, the posture of the objective lens 1 can be changed, and to move the objective lens 1 in the tracking direction of the optical disk, a drive current is transmitted by the FPC 4c to the third flexible member 3h and to the tracking coil assembly 7, and is returned, through the other third flexible member 3h, to the FPC 4c. Then, in accordance with a current flowing through the tracking coil assembly 7, the electromagnetic force is generated by the magnetic field of the magnets 8, and the objective lens 1 is moved in the tracking direction.

According to the objective lens driver 11 of this embodiment, which has the above described arrangement and that is produced by employing the above described method, the flexible members 3 are arranged in two rows in the direction of the thickness of the lens holder 2, and in two columns in the direction of the width, i.e., there are four members on either side and a total of eight members are arranged. Therefore, all of the flexible members 3 can be connected to the first focusing coil 6a, the second focusing coil 6b and the tracking coil assembly 7, and the space required for the connections can be obtained. Further, the space is also obtained that is required for the connection of the flexible members 3 to the FPC 4c, which is a conductive line for feeding a current to the first focusing coil 6a, the second focusing coil 6b and the tracking coil assembly 7. Additionally, when the flexible members 3, the lens holder 2 and the fixing member 4 are to be integrally formed, the thickness of a spacer to be inserted between these members 3 can also be obtained. Since a total of eight flexible members 3 are provided for the objective lens driver 11 of this embodiment, the inclination of the objective lens 1, relative to the optical disk, can be controlled by feeding a current to the first and the second focusing coils 6a and 6b and the tracking coil assembly 7. Further, since the flexible members 3 are arranged in two rows, in the direction of the thickness, a type of thin objective lens driver can be provided.

### Second Embodiment

A second embodiment of the present invention will now be described while referring to the drawings. For an objective lens driver of the second embodiment, structures differing from those of the first embodiment are provided for a first focusing coil and a second focusing coil. Since the objective lens driver and the manufacturing method for the second embodiment are the same as those for the first embodiment, except for the structures of the first and the second focusing coils and the connections to flexible members, the explanation given for the first embodiment is employed. FIG. 9 is a diagram showing the wire winding directions of the first focusing coil and the second focusing coil in the second embodiment. FIG. 10A is a diagram showing the connections of the focusing coils and a tracking coil assembly to the flexible members when viewed from the side opposite a fixing member. And FIG. 10B is a diagram showing these connections when viewed from the fixing member. As well as in the first embodiment, the focusing coils 13 are a first focusing coil 13a and a second focusing coil 13b.

In FIG. 9, the first focusing coil 13a is a coil formed by winding two wires in the same direction using a single lead line 13c. Or the two wires wound in the same direction may be connected by the lead line 13c. The second focusing coil 13b is a coil formed by winding two wires in opposite directions using one lead line 13d. Or two wires wound in opposite directions may be connected by the lead line 13d. When the focusing coils 13a and 13b are to be fixed to a lens holder 2, one of the wires of the first focusing coil 13a and one of the wires of the second focusing coil 13b are aligned with a second through hole 2b, while the other wire of the first focusing coil 13a and the other wire of the second focusing coil 13b are aligned with the other second through hole 2b.

In FIGS. 10A and 10B, as well as in the first embodiment, flexible members 3 are arranged in two columns and in two rows at both ends of the lens holder 2. As explained in the first embodiment, the flexible members 3 may be arranged in three or more columns, while the ends of the lead line 13c for the first focusing coil 13a are connected to first flexible members 3f that are arranged at both ends of the lens holder 2. The ends of the lead line 13d for the second focusing coil 13b are connected to second flexible members 3g that are arranged at both ends of the lens holder 2. And as well as in the first embodiment, the ends of lead lines 7a for a tracking coil assembly 7 are connected to third flexible members 3h that are arranged at both ends of the lens holder 2. No lead lines are connected to fourth flexible members 3i.

A drive current is supplied by the first flexible member 3f to the first focusing coil 13a, and is returned to the first flexible member 3f. A drive current is supplied by the second flexible member 3g to the second focusing coil 13b, and is returned to the second flexible member 3g. When a drive current is fed to the first focusing coil 13a, an electromagnetic force is generated in the same direction along the two wires of the first focusing coil 13a, and both ends the lens holder 2 are moved in the focusing direction of an optical disk, while the parallel posture of the lens holder 2 is maintained. That is, when a drive current is fed to the first focusing coil 13a, the entire objective lens 1 can be moved in the focusing direction of the optical disk. On the other hand, when a drive current is fed to the second focusing coil 13b, opposite winding directions are used for the two wires of the second focusing coil 13b, and in the two wires, electromagnetic forces are generated in opposite directions. Thus, one end of the lens holder 2 is moved in the focusing direction of the optical disk, while the other end is moved in the opposite focusing direction. Therefore, when a drive current is supplied to the second focusing coil 13b, the inclination of the objective lens 1, relative to the optical disk, can be adjusted.

The fourth flexible member pair 3i may be eliminated, and one of these connections may be selected: the connection of the first focusing coil 13a to two first flexible member pairs 3f, the connection of the second focusing coil 13b to two second flexible member pairs 3g, or the connection of the tracking coil assembly 7 to two third flexible member pairs 3h. In the second embodiment, since the first focusing coil 13a has as a function the moving the entire objective lens 1 in the focusing direction, and the second focusing coil 13b has as a function the adjustment of the inclination of the objective lens 1, the coils 13a and 13b can be independently operated. Therefore, the first focusing coil 13a can be connected to two first flexible member pairs 3f, and the second focusing coil 13b can be connected to two second flexible member pairs 3g. When two pairs of flexible members 3b are employed, the electrical resistance of the flexible members 3 can be reduced by half, and a large drive current can be supplied to the coil connected to two pairs of flexible members 3. Thus, the sensitivity of the objective lens driver 11 can be increased.

As described above, for the objective lens driver of this embodiment, as well as in the first embodiment, four flexible members 3 are arranged on either side, e.g., a total of eight members are arranged in two rows in the direction of thickness of the lens holder 2 and in two columns in the direction of width. Therefore, all the flexible members 3 connected to the first focusing coil 13a, the second focusing coil 13b and the tracking coil assembly 7 can be connected. Thus, a current can be respectively supplied to the first focusing coil 13a, which moves the entire objective lens 1 in the focusing direction of the optical disk, the second focusing coil 13b, which adjusts the inclination of the objective lens 1 relative to the optical disk, and the tracking coil assembly 7. This being the case, inclination control of the objective lens 1, relative to the optical disk, can be performed. Further, since the flexible members 3 are arranged in two rows in the direction of thickness, a type of thin objective lens driver 11 can be provided.

### Third Embodiment

A third embodiment of the present invention will now be described while referring to the drawings. The third embodiment relates to an optical pickup device that employs an objective lens driver that was explained in either the first or the second embodiment. FIG. 11 is a diagram showing the configuration of the optical system of the optical pickup device for the third embodiment, and FIG. 12 is a top view of the arrangement of the optical pickup device of the third embodiment. For an optical pickup device 35 in the third embodiment, an objective lens driver 11 mounting an objective lens 1 is fixed to a base 34. Also, a laser source 21, a diffraction element 22, a beam splitter 23, a mirror 24, a collimating lens 25, a wave plate 26, an angle conversion prism 27, a path elevating prism 28, an astigmatism lens 30, a light receiving sensor 31, a filter 32 and a forelight monitor 33 are directly fixed to the base 34 or are fixed thereto through attachment members.

First, the arrangement will be explained. Since the objective lens 1 and the objective lens driver 11 are the same as those for the first or the second embodiment or those that will be explained for a fifth embodiment, the explanation given for them is employed.

The laser source 21 is a so-called double wavelength semiconductor laser, a light source secured by closely assembling multiple light sources. The double wavelength semiconductor laser includes a light source, which emits a laser beam having a wavelength λ1 (about 650 nm) used for a DVD, and a light source, which emits a laser beam having a wavelength λ2 (about 780 nm) used for a CD. The distance between these light sources is about 110 μm. As double wavelength semiconductor lasers, there are a so-called monolithic double wavelength semiconductor laser, wherein light emission sources for multiple wavelengths are integrated within a single semiconductor device, and a so-called hybrid double wavelength semiconductor laser, wherein multiple semiconductor devices having different wavelengths are arranged adjacent to each other within a single package. In the third embodiment, the monolithic double wavelength semiconductor laser is employed. Further, it is preferable that the laser source 21 be a so-called frame laser, wherein a laser device is fixed to a frame by means of a sub-mount, because the thickness of the optical pickup device 35 can be reduced. It should be noted that a laser beam having a wavelength λ1 and a laser beam having a wavelength λ2 that are emitted as the laser beam 21 are both P polarized.

The diffraction element 22 is provided by forming, on a transparent substrate, such as optical glass, a diffraction grating that diffracts a laser beam having a wavelength λ1, separating this light into 0-order light and ±1-order light, and that passes a laser beam having a wavelength λ1, and a diffraction grating that passes a laser beam having a wavelength λ1 and that diffracts a laser beam having a wavelength λ2, separating this light into 0-order light and ±1-order light.

For the diffraction element 22, only raised and recessed portions need be formed on both faces of the transparent substrate, and while taking into account the wavelength in use, the refractive index, the grating depth and the diffraction efficiency, only a diffraction grating that diffracts only a laser beam having a wavelength λ1 and a diffraction grating that diffracts only a laser beam having a wavelength λ2 need be formed. Furthermore, two materials may be employed to form diffraction gratings, and such diffraction gratings may be assembled together to produce an anomalous dispersion phenomenon that is caused by one of the materials, while the refractive indexes of the two materials are equal at one of the wavelengths, and are different at the other wavelength.

The beam splitter 23 is formed of optical glass or optical plastic, and includes internally an inclined face 23a, on which a polarizing separation film is deposited. Most of a P polarized laser beam is passed through the polarizing separation film, while only a part is reflected, and an S polarized laser beam is totally reflected by the polarizing separation film.

The mirror 24 is used to bend a light path in order to provide a compact optical system. And a total reflection film is formed on the surface of the mirror 24.

The collimating lens 25 is used to change a divergent laser beam emitted by the laser source 21 into a parallel beam. And the collimating lens 25 is formed of optical glass or optical plastic.

The wave plate 26 changes P polarized light in a laser beam emitted by the laser source 21 into circularly polarized light, or changes circularly polarized light in a laser beam reflected by an optical disk 29 into S polarized light. The refractive index and the thickness of the wave plate 26 are so designated that they can act on both a laser beam having a wavelength λ1 and a laser beam having a wavelength λ2.

The angle conversion prism 27 provides an angle in a direction perpendicular to the optical disk 29 for a laser beam that is substantially parallel to the face of the optical disk 29, so that the angle of the laser beam that enters the path elevating prism 28 can be optimized, and the thickness of the path elevating prism 28 can be minimized.

The path elevating prism 28 is located immediately below the objective lens 1 in order to raise a laser beam in a direction perpendicular to the optical disk 29.

The optical disk 29 of a CD type is, for example, a CD, a CD-ROM or a CD-R/RW, and the optical disk 29 of a DVD type is, for example, a DVD-ROM, a DVD±R/RW or a DVD-RAM. Regardless of the CD type or the DVD type, the optical disk 29 is recordable and reproducible, except for a reproduction only medium. In the third embodiment, the optical pickup device is used for a CD and a DVD; however, the general character is not lost when a so-called BD and an HD DVD are employed.

The astigmatism lens 30 is a lens that provides an astigmatism effect for a laser beam, reflected by the optical disk 29, in order to perform focus control while using the astigmatic method. The astigmatism lens 30 is formed either of optical glass or of optical plastic.

The light receiving sensor 31 receives a laser beam that is emitted by the laser source 21 and is reflected by the optical disk 29, and changes the reflected light into an electric signal, such as a tracking control signal, a focus control signal or an RF signal.

The filter 32 is used to adjust, within an appropriate range value, the quantity of a laser beam that is separated by the beam splitter 23 and enters the forelight monitor 33. As the filter 23, a light absorption film may be formed on the side face of the beam splitter 23.

The forelight monitor 33 receives a laser beam that has been emitted by the laser source 21 and reflected and separated by the beam splitter 23, and converts the light quantity of this laser beam into an electric signal and outputs the electric signal. This electric signal is employed to control the light quantity of a laser beam emitted by the laser source 21.

The base 34 serves as the framework of the optical pickup device 35, and is composed of an alloy, such as a Zn alloy or an Mg alloy, or a hard resin material.

For the objective lens driver 11 mounting the objective lens 1, a yoke 5 is bonded to the base 34. The laser source 21, the diffraction element 22, the beam splitter 23 and the light receiving sensor 31, to which the astigmatism lens 30 is attached, are mounted on a common mounting member that is then attached to the base 34. The mirror 24, the collimating lens 25, the wave plate 26, the angle conversion prism 27 and the path elevating prism 28 are attached to the base 34. The filter 32 and the forelight monitor 33 are also mounted on the base 34.

A light path will now be explained. As shown in FIG. 11, a laser beam having a wavelength λ1 or 80 2, which is emitted by the laser source 21, is diffracted by the diffraction element 22 and is separated into 0-order light and ±1-order light, and these separate beams enter the beam splitter 23. Then, when the separated laser beams enter the light receiving sensor 31, the laser beam is converted into an electric signal for tracking control. A part of the laser beam is reflected by the polarizing separation film formed on the inclined face 23a of the beam splitter 23, and the reflected light passes through the filter 32, enters the forelight monitor 33, and is converted into an electric signal for controlling the light quantity. Most of the laser beam that passes through the polarizing separation film is reflected by the mirror 24, and the reflected light enters the collimating lens 25. In the collimating lens 25, the divergent light is changed into substantially parallel light, which then enters the wave plate 26. The laser beam, once it has entered the wave plate 26, is converted into linear P polarized light and circularly polarized light. The circularly polarized light enters the angle conversion prism 27, where the light path is slightly changed, and thereafter, the light is guided to the path elevating prism 28. Then, the path elevating prism 28 changes the transmission direction of the laser beam to a direction substantially perpendicular to the optical disk 29, and the laser beam enters the objective lens 1. Sequentially, the substantially parallel light of the laser beam is changed into focusing light by the objective lens 1, and the focusing light enters the optical disk 29. The laser beam that enters the optical disk 29 is focused on the recording face of the optical disk 29.

The laser beam reflected by the recording face of the optical disk 29 passes through the objective lens 1, the path elevating prism 28, the angle conversion prism 27, the wave plate 26 and the collimating lens 25, and is reflected by the mirror 24, and the reflected light enters the beam splitter 23. At the objective lens 1, the laser beam is changed from divergent light into substantially parallel light. And at the wave plate 26, circularly polarized light is changed into linearly polarized light that is perpendicular to the linearly polarized light traveling along the above described path, i.e., is changed to S polarized light. At the collimating lens 25, the parallel light is changed into focusing light, and the laser beam that has entered the beam splitter 23 is totally reflected by the polarizing separation film and enters the astigmatism lens 30. At the astigmatism lens 30, astigmatism is provided for the laser beam, and the resultant laser beam is transmitted to the light receiving sensor 31 and is converted into an electric signal for focus control. Further, at least a part of the laser beam that enters the light receiving sensor 31 is converted into an RF signal.

A focus control signal and a tracking control signal generated by the light receiving sensor 31 are transmitted to the main body of an optical disk apparatus. Following this, a drive current is fed to an FPC 4c of the objective lens driver 11, and is supplied, from the FPC 4c, through flexible members 3 to a first focusing coil 6a or 13a and a second focusing coil 6b or 13b and a tracking coil assembly 7, and an electromagnetic force is generated. As a result, the objective lens 1 is moved in the focusing direction or the tracking direction of the optical disk 29.

As described above, for the optical pickup device 35 of the third embodiment, the objective lens driver 11 mounting the objective lens 1 is thin and the inclination of the objective lens 1 relative to the optical disk 29 can be adjusted. Therefore, the recording and reproduction of both a CD and a DVD can be coped with. Thus, according to the third embodiment, a type of thin optical pickup device 35 can be provided that can cope with the recording and reproduction of both a CD and a DVD.

### Fourth Embodiment

A fourth embodiment of the present invention will now be described. FIG. 13A is a top view of the structure of an optical pickup module according to the fourth embodiment, and FIG. 13b is a bottom view of this structure. And FIG. 14 is a diagram showing the structure of an optical disk apparatus according to the fourth embodiment. The fourth embodiment provides an optical disk apparatus that includes an objective lens driver explained in the first or the second embodiment, or an objective lens driver that will be explained in the fifth embodiment.

While referring to FIGS. 13A and 13B, an optical pickup module 40 is the driving mechanism for an optical disk apparatus 50 that includes a rotation unit, for rotating an optical disk, and a moving unit, for bringing an optical pickup device 35 near or separating it from the rotation unit. A base 41 serves as the framework of the optical pickup module 40 that is constituted by directly or indirectly arranging individual parts on the base 41.

The rotation unit includes a spindle motor 42 having a turn table 42a, on which an optical disk is to be placed. The spindle motor 42 is fixed to the base 41, and generates a rotational force for rotating an optical disk.

The moving unit includes a feed motor 43, a screw shaft 44 and guide shafts 45 and 46. The feed motor 43 is fixed to the base 41, and generates a rotational force required by the optical pickup device 35 to move between the inner circumference and the outer circumference of an optical disk. A stepping motor or a DC motor, for example, can be employed as the feed motor 43. A spiral groove is formed in the screw shaft 44, and the screw shaft 44 is connected to the feed motor 43 directly or through several gears. In the fourth embodiment, through gears, the screw shaft 44 is connected to the feed motor 43. The guide shafts 45 and 46 are each connected, at both ends, to the base 41 through a support member, and movably support the optical pickup device 35. The optical pickup device 35 includes a rack 47 having guide teeth that engage the groove of the screw shaft 44., and then the rack 47 changes into a linear driving force the rotational force of the feed motor 43 transmitted to the screw shaft 44, the optical pickup device 35 can move between the inner circumference and the outer circumference of the optical disk.

The structure of the rotation unit is not limited to that in the fourth embodiment, so long as an optical disk can be rotated a predetermined number of revolutions. Also, the structure of the moving unit is not limited to that in the fourth embodiment, so long as the optical pickup device 35 can be moved between predetermined positions along the inner and outer circumferences of the optical disk.

The optical pickup device 35, to which a cover is attached, has the structure shown in FIG. 12 and includes the objective lens driver 11 having the objective lens 1, as explained in the first or the second embodiment, or an objective lens driver that will be explained in the fifth embodiment. Therefore, the optical pickup device 35 is made thin, and can cope with the recording and reproduction of an arbitrary type of CD or DVD. The optical pickup device 35 emits a laser beam to an optical disk in order, at least, to perform the recording or the reproduction of information relative to the optical disk. At this time, in order to introduce to the optical disk, at a right angle, the laser beam emitted by the optical pickup device 35, the inclinations of the guide shafts 45 and 46 are adjusted by the adjustment mechanism constituting the support members.

An FPC 48 electrically connects the optical pickup device 35 to the main body of the optical disk apparatus 50. The FPC 48 serves as a conductive line, for supplying power and for transmitting an electric signal from the main body of the optical disk apparatus 50 to the optical pickup device 35, and also as a conductive line, for transmitting an electric signal from the optical pickup device 35 to the main body of the optical disk apparatus 50.

A cover 49 has an opening, through which at least a part of the objective lens driver 11 of the optical pickup device 35, including the objective lens 1, and the turn table 42a of the spindle motor 42 are exposed. Furthermore, in the fourth embodiment, the feed motor 43 and the guide shaft 46 are also exposed through this opening, so that the thickness of the optical pickup module 40 can be reduced, to the equivalent of the thickness of the cover 49.

In FIG. 14, a case 51 is formed by securely assembling an upper case 51a and a lower case 51b using screws. A tray 52 provided for the case 51 is retractable, and the optical pickup module 40 is arranged on the tray 52 from the bottom. An opening is formed in the tray 52, and at least part of the objective lens driver 11, including the objective lens 1 and the turn table 42a of the spindle motor 42, and at least part of the cover 49 are exposed through the opening. A bezel 53 is formed on the front end face of the tray 52 to close the slot of the tray 52 when the tray 52 is loaded into the case 51. An eject switch 54 is provided for the bezel 53, and by pressing the eject switch 54, the tray 52 is unlocked from the case 51 and can be extracted from the case 51. Rails 55 are attached to both sides of the tray 52 and to the case 51 to permit the tray 52 to slide freely. A circuit board (not shown) is internally provided for the case 51 and the tray 52, and a signal processing IC and a power circuit are mounted. An external connector 56 is connected to a power/signal line provided for an electronic apparatus, such as a computer, so that power can be supplied, through the external connector 56, to the optical disk apparatus 50, an external electric signal can be transmitted to the optical disk apparatus 50, or an electric signal generated by the optical disk apparatus can be transmitted to the electronic apparatus.

As described above, in the fourth embodiment, a thin objective lens driver 11 is provided for the optical pickup device 35 mounted on the optical disk apparatus 50, and can adjust the inclination of the objective lens relative to an optical disk. Therefore, the recording and reproduction of both a CD and a DVD can be coped with. Thus according to the fourth embodiment, a type of thin optical disk apparatus 50 can be provided that can cope with the recording and reproduction of both a CD and a DVD.

### Fifth Embodiment

A fifth embodiment of the present invention will now be described while referring to the drawings. FIG. 16 is a top view of an objective lens driver according to the fifth embodiment. Since an objective lens driver 71 for the fifth embodiment has the same configuration as has the objective lens driver 11 of the first embodiment, the explanation given in the first embodiment is employed. That is, the objective lens 1 is replaced with an objective lens 61, the lens holder 2 is replaced with a lens holder 62, the fixing member 4 is replaced with a fixing member 64, the yoke 5 is replaced with a yoke 65, the tracking coil assembly 7 is replaced with a tracking coil assembly 67, the magnets 8 are replaced with magnets 68 and the damping gel 12 is replaced with a damping gel 69. Focusing coils 66 in the fifth embodiment may be either the same as the focusing coils 6 in the first embodiment or the focusing coils 13 in the second embodiment. In the fifth embodiment, since the arrangement and the shape of flexible members 63 differ from those of the flexible members 3 in the first embodiment, an explanation for them will be given.

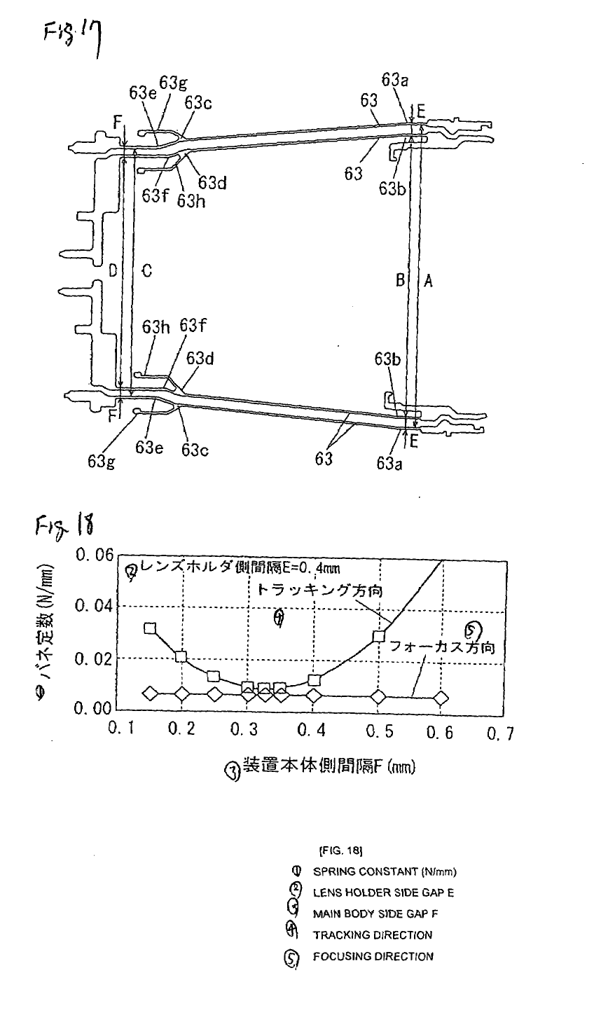

FIG. 17 is a diagram showing the arrangement of the flexible members 63 in the fifth embodiment. In FIG. 17, only the flexible members 63 in FIG. 16 are especially shown. The right side on the sheet is near the lens holder 62, and the left side on the sheet is near the fixing member 64, i.e., near the driver main body. In this example, the flexible members 63 are arranged in two columns and in two rows at both ends of the lens holder 62; however, the arrangement is not limited to this example. The flexible members 63 may be arranged in three or more columns and in two rows, or when no restriction applies to the thickness of the objective lens driver 71, they may be arranged in three or more columns and in three or more rows. Either this, or the flexible members 63 may be arranged in three or more columns and in one row. Furthermore, in this embodiment, the same shape is employed for the flexible member 63 in the top row and the flexible member 63 in the bottom row; however, the shape is not limited to this example, and the individual flexible members 63 may be formed in optimal shapes. Further, as well as in the first embodiment, the gap between the flexible members 63 in the top and bottom rows is 0.6 mm, the thickness of the flexible member 63 is 0.05 mm, and the width of the center portion is 0.09 mm, while the width near the lens holder 62 and near the fixing member 64 is 0.07 mm. The flexible member 63 is formed of a flexible conductive material, such as iron alloys or copper alloys (e.g., copper-beryllium alloys).

The outer flexible member 63, which is led from the root of the lens holder 62 side, is extended in a direction substantially parallel to a line connecting the center of the lens holder 62 and the center of the fixing member 64, until it reaches a refraction point 63a. At the refraction point 63a, the direction of the flexible member 63 is changed slightly inward, and it continues until it reaches a refraction point 63c. At the refraction point 63c, the direction the flexible member 63 is changed further inward, until it reaches a refraction pint 63e. Finally, at the refraction point 63e, the direction of the flexible member 63 is changed, until it is substantially parallel to a line that connects the center of the lens holder 62 and the center of the fixing member 64, and it continues until it reaches the root of the fixing member 64 side. In this case, the refraction point 63a is located near the lens holder 62, and the refraction point 63c is located near the fixing member 64. For the outer flexible member 63, the distance between the refraction points 63a and 63c is the longest, and a branch 63g splits outward at the refraction point 63c. The branch 63g is used to adjust the flexibility of the outer flexible member 63 and does not reach the flexible member 64.

On the other hand, the inner flexible member 63, which is led from the root of the lens holder 62 side, is extended almost parallel to a line connecting the center of the lens holder 62 and the center of the fixing member 64 until it reaches a refraction point 63b. At the refraction point 63b, the direction of the flexible member 63 is changed to slightly inward, until it reaches a refraction point 63d. At the refraction point 63d, the direction of the flexible member 63 is changed further inward, until it reaches a refraction pint 63f. Finally, at the refraction point 63f, the direction of the flexible member 63 is changed until it is almost parallel to a line that connects the center of the lens holder 62 and the center of the fixing member 64, and continues until it reaches the root of the fixing member 64 side. In this case, the refraction point 63b is located near to the lens holder 62, and the refraction point 63d is near the fixing member 64. For the inner flexible member 63, the distance between the refraction points 63b and 63d is the longest, and a branch 63h is split off inward at the refraction point 63d. The branch 63h is used to adjust the flexibility of the inner flexible member 63, and does not reach the fixing member 64.

The outer flexible member 63 extended from the root of the lens holder 62 side to the refraction point 63a is substantially parallel to the inner flexible member 63 extended from the root of the lens holder 62 side to the refraction point 63b. Further, the outer flexible member 63, extended from the refraction point 63a to the refraction point 63c, is almost parallel to the inner flexible member 63 extended from the refraction point 63b to the refraction point 63d. Also, the outer flexible member 63 extended from the refraction point 63c to the refraction point 63e is almost parallel to the inner flexible member 63 extended from the refraction point 63d to the refraction point 63f. Furthermore, the outer flexible member 63 extended from the refraction point 63e to the root of the fixing member 64 side is almost parallel to the inner flexible member 63 extended from the refraction point 63f to the root of the fixing member 64 side.

This is done because, as will be described later, the gap on the fixing member 64 side between the outer flexible member 63 and the inner flexible member 63, which are provided on the same face, is smaller than the gap on the lens holder 62 side, and the flexible members 63 of this form are cut out by a punch press as described in the first embodiment. That is, it is difficult, while a small gap on the fixing member 64 side is maintained, for flexible members 63 having a long length to be cut out by a punch press. Therefore, long portions of the flexible members 3 are punched out on the lens holder 62 side, which is a large gap side, so that the portions to be punched out on the small gap side are reduced.

In the fifth embodiment, a gap A between both outer flexible members 63 on the lens holder 62 side is regarded as being about 11.3 mm, and a distance B between the inner flexible members 63 is regarded as being about 10.5 mm. A distance C between both outer flexible members 63 on the fixing member 64 side is regarded as being about 9.3 mm, and a distance D between the inner flexible members 63 is regarded as being about 8.6 mm, shorter than that on the lens holder 62 side. The gap on the lens holder side can not be very small because the objective lens 61, the focusing coils 66 and the tracking coil assembly 67 are mounted on the lens holder 62; however, since no such condition exists for the fixing member 64 side, the gap on the fixing member 64 side can be smaller than the gap on the lens holder 62 side. Accordingly, the size and the weight of the objective lens driver 71 can be reduced.

Additionally, a gap E between the outer flexible member 63 and the inner flexible member 63 on the lens holder 62 side is regarded as being about 0.40 mm, and a gap F between the outer flexible member 63 and the inner flexible member 63 on the fixing member 64 side is regarded as being about 0.32 mm. At this time, the gap F is smaller than the gap E. FIG. 18 is a diagram showing the simulation results of spring constants in the focusing direction and the tracking direction in a case wherein the gap F on the driver main body, which is the fixing member 64 side, is changed while the gap E on the lens holder 62 side is maintained as 0.4 mm. The spring constant in the focusing direction is substantially a fixed value, regardless of the gap F. However, as a trend for the spring constant, when the gap F is smaller than 0.4 mm, i.e., 0.30 to 0.35 mm, the spring constant in the tracking direction is reduced, and when the gap F is around 0.32 mm, the minimum spring constant is reached. In the range for the gap F of from 0.30 to 0.35 mm, the spring constant in the focusing direction and the spring constant in the tracking direction have almost equal values. When the spring constants are almost equal in the focusing direction and in the tracking direction, the flexibility easily becomes well balanced in the focusing direction and in the tracking direction.

The spring constant reaches the minimum in the tracking direction when the ratio of the gap C to the gap A or the ratio of the gap D to the gap B is almost equal to the ratio of the gap F to the gap E. In the fifth embodiment, the ratio of the gap C to the gap A is 9.3/11.3=about 0:8, the ratio of the gap D to gap B is 8.6/10.5=about 0.8 and the ratio of the gap F to the gap E is 0.32/0.40=0.8. Further, although not shown, when the gaps C and D are about 1.25 times the gaps A and B, the gap F for which the spring constant in the tracking direction is the minimum is about 0.5 mm.

Furthermore, since multiple refraction points 63a to 63f are located en route, the outer and inner flexible members 63, led respectively from the roots of the lens holder 62 side and the fixing member 64 side, can be extended substantially parallel to the line that connects the center of the lens holder 62 and the center of the fixing member 64. Therefore, the flexibility can be stabilized.

The branch 63g that adjusts the flexibility of the outer flexible member 63 is split outward from the outer flexible member 63, while the branch 63h that adjusts the flexibility of the inner flexible member 63 is split inward from the inner flexible member 63. Therefore, the small gap can be maintained between the outer and inner flexible members 63 on the fixing member 64 side.

As described above, according to the objective lens driver 71 of the fifth embodiment, the flexible members 63 are arranged at both ends of the lens holder 62 in multiple columns in the direction of width and in two rows in the direction of thickness. Therefore, a total eight or more flexible members 63 are provided. Thus, an appropriate number of the flexible members 63 can be prepared for feeding a current to the focusing coils 66 and the tracking coil assembly 67, and the inclination of the objective lens 61 relative to an optical disk can be adjusted. Further, since the flexible members 63 are arranged in two rows in the direction of thickness, a type of thin objective lens driver can be provided. Additionally, since the spring constant in the tracking direction can be reduced until almost equal to the spring constant in the focusing direction, the flexibility both in the tracking direction and in the focusing direction can be well balanced.

As described above, the objective lens driver, produced by the objective lens driver manufacturing method of this invention, the optical pickup device and the optical disk apparatus can control the inclination of the objective lens relative to an optical disk, and these devices are appropriate for mounting in an electronic apparatus, such as a thin type notebook computer.

This application is based upon and claims the benefit of priority of Japanese Patent Application No 2006-176214 filed on Jun. 6, 1927, Japanese Patent Application No 2006-015916 filed on Jun. 1, 1925, the contents of which are incorporated herein by reference in its entirety.

What is claime is:

1. An objective lens driver, comprising:
a lens holder, for holding an objective lens that focuses a laser beam on an optical disk;
a first focusing coil, for moving one end of the lens holder in a focusing direction of the optical disk;
a second focusing coil, for moving the other end of the lens holder in the focusing direction of the optical disk;
a tracking coil assembly, for moving the lens holder in a tracking direction of the optical disk; and
flexible members including
a first flexible member pair, for feeding a current to the first focusing foil,
a second flexible member pair, for feeding a current to the second focusing coil, and
a third flexible member pair, for feeding a current to the tracking coil assembly,
wherein the lens holder is flexibly supported at a driver main body by the flexible members, and the flexible members are arranged in a plurality of columns on both ends of the lens holder in the tracking direction of the optical disk.

2. An objective lens driver comprising:
a lens holder, for holding an objective lens that focuses a laser beam on an optical disk;
a first focusing coil, for moving one end of the lens holder in a focusing direction of the optical disk;
a second focusing coil, for moving one end of the lens holder in the focusing direction of the optical disk and for moving the other end in an opposite focusing direction of the optical disk;
a tracking coil assembly, for moving the lens holder in a tracking direction of the optical disk; and
flexible members including
a first flexible member pair, for feeding a current to the first focusing foil,
a second flexible member pair, for feeding a current to the second focusing coil, and
a third flexible member pair, for feeding a current to the tracking coil assembly,
wherein the lens holder is flexibly supported at a driver main body by the flexible members, and the flexible members are arranged in a plurality of columns on both ends of the lens holder in the tracking direction of the optical disk.

3. The objective lens driver according to claims 1, wherein the flexible members are arranged, at both ends of the lens holder, in two columns in the tracking direction of the optical disk and in two rows for the focusing direction of the optical disk.

4. The objective lens driver according to claim 3, wherein the flexible members include a fourth flexible member pair that is not connected to either the first focusing coil, the second focusing coil or the tracking coil assembly.

5. The objective lens driver according to claim 3, wherein flexible members arranged at both ends of the lens holder in columns, near the optical disk, are located substantially on the same plane.

6. The objective lens driver according to claim 3, wherein flexible members arranged, on both sides of the lens holder, in columns that are farther from the optical disk are substantially positioned on the same plane.

7. The objective lens driver according to claim 1, wherein the flexible members are split near the driver main body, and one branch of each of the flexible members is fixed to the driver main body.

8. The objective lens driver according to claim 7, wherein at the least, the flexible members arranged in the innermost column include a bent portion, between a split position and the driver main body.

9. An objective lens driver according to claim 7, wherein flexible members nearer the driver main body than the split position are covered with a damping gel.

10. The objective lens driver according to claim 1, wherein the flexible members are embedded in the lens holder.

11. The objective lens driver according to claim 10, wherein at least a part of connections made between the first focusing coil and the first flexible member pair, between the second focusing coil and the second flexible member and between the tracking coil assembly and the third flexible member is made on the side of the lens holder opposite the driver main body.

12. Te objective lens driver according to claim 1, wherein the driver main body includes a fixing member for embedding the flexible members.

13. The objective lens driver according to claim 12, wherein a land for a flexible print board is located on the side of the fixing member opposite the lens holder, and the first flexible member pair, the second flexible member pair and the third flexible member pair are connected to the flexible print board using the land.

14. The objective lens driver according to claim 1, wherein the driver main body includes:
a flat portion, for securing the fixing member in which the flexible members are embedded;
arm portions, extending from both ends of the flat portion, substantially in the same direction;
first upright yokes, formed by bending the flat portion between the arm portions at substantially a right angle; and
second upright yokes, formed by bending the arm portions along oblique folds, at substantially right angles, toward the same side as the first upright yokes, so that distal ends of the arm portions face the first upright yokes.

15. The objective lens driver according to claim 3, wherein a gap at which the flexible members are arranged in two rows, at both ends of the lens holders, is equal to or smaller than 1 mm.

16. The objective lens driver according to claim 1, wherein widths of the flexible members vary among a portion near the lens holder, a portion near the driver main body and the center portion.

17. The objective lens driver according to claim 16, wherein, since the widths of the flexible members are such that their center portions are wide and their portions near the lens holder and their portions near the driver main body are narrow.

18. A method for manufacturing an objective lens driver comprising:
a first step of producing a first frame member, which includes four flexible members that are integrally formed with a frame and are arranged on the side near an optical disk, and a second frame member, which includes four flexible members that are integrally formed with a frame and are arranged on the side farther from the optical disk;
a second step of integrally forming a lens holder and a fixing member with the first frame member and the second frame member, with the first frame member and the second frame member being separated a predetermined distance;
a third step of fixing a first focusing coil, a second focusing coil and tracking coil assembly to the lens holder, and connecting the first focusing coil to a first flexible member pair of the eight flexible members, connecting the second focusing coil to a second flexible pair of the eight flexible members, and connecting the tracking coil assembly to a third flexible member pair of the eight flexible members;
a fourth step of locating an objective lens at a predetermined position on the lens holder; and
a fifth step of separating the flexible members from the frames by cutting.

19. An optical disk apparatus comprising an objective lens driver that includes:
a lens holder, for holding an objective lens that focuses a laser beam on an optical disk;
a first focusing coil, for moving one end of the lens holder in a focusing direction of the optical disk;
a second focusing coil, for moving the other end of the lens holder in the focusing direction of the optical disk;
a tracking coil assembly, for moving the lens holder in a tracking direction of the optical disk; and
flexible members including
a first flexible member pair, for feeding a current to the first focusing foil,
a second flexible member pair, for feeding a current to the second focusing coil, and
a third flexible member pair, for feeding a current to the tracking coil assembly,
wherein the lens holder is flexibly supported at a driver main body by the flexible members, and the flexible members are arranged in a plurality of columns on both ends of the lens holder in the tracking direction of the optical disk.

20. The objective lens driver according to claim 1, wherein a ratio of a distance, on the lens holder side, between a flexible member located in the innermost column and a flexible member located in the outermost column, relative to a distance between the two on the driver main body side, is substantially equal to a ratio of a distance, on the lens holder side, between the flexible members located at both ends of the lens holder, relative to a distance for the two on the driver main body side.

21. The objective lens driver according to claim 1, wherein the distance, on the driver main body side, of the flexible members located at both ends of the lens holder is equal to or shorter than a distance on the lens holder side.

22. The objective lens driver according to claim 25, wherein the distance on the driver main body side between the flexible member located in the innermost column and the flexible member located in the outermost column is equal to or smaller than the distance on the lens holder side.

23. The objective lens driver according to claim 1, wherein the flexible members include at least one refraction point, and adjacent flexible members arranged in the same row are substantially parallel between the lens holder and the refraction point and between the refraction point and the driver main body.

24. The objective lens driver according to claim 24, wherein, when the flexible members have a plurality of refraction points, adjacent flexible members arranged in the same row are substantially parallel between the individual refraction points.

25. The objective lens driver according to claim 7, wherein, as for the flexible member arranged in the innermost column, an outward branch is fixed to the driver main body, and as for the flexible member arranged in the outermost column, an inward branch is fixed to the driver main body.
